(19) United States
(12) Patent Application Publication
(10) Pub. No.: US 2025/0240130 A1
(43) Pub. Date: Jul. 24, 2025

(54) Dynamic Selection of Sounding Reference Signal Frequency Hopping Configurations

(71) Applicant: Dell Products, L.P., Round Rock, TX (US)

(72) Inventor: Sunil Kumar, Bangalore (IN)

(21) Appl. No.: 18/420,558

(22) Filed: Jan. 23, 2024

(51) Int. Cl. H04L 5/00

(52) U.S. Cl. CPC H04L 5/0012; H04L 5/0051

(57) ABSTRACT

A system can, as part of attaching with user equipment (UE), determine a first sounding reference signal (SRS) frequency hopping configuration. The system can communicate the first SRS frequency hopping configuration to the UE. The system can, after the attaching with the UE, receive respective first SRS reports from the UE that are configured according to the first SRS frequency hopping configuration. The system can, in response to identifying that a power consumption of the UE satisfies a power limitation criterion, or that a UE channel condition satisfies a channel condition criterion, modify the first SRS frequency hopping configuration to a second SRS frequency hopping configuration, and communicate the second SRS frequency hopping configuration to the UE. The system can, after communicating the second SRS frequency hopping configuration to the UE, receive respective second SRS reports from the UE that are configured according to the second SRS frequency hopping configuration.

### BACKGROUND

In cellular broadband communications, user equipment can report information to a base station that the base station uses to facilitate the communications.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can, as part of attaching with a user equipment, determine a first sounding reference signal frequency hopping configuration for communications with the user equipment. The system can communicate the first sounding reference signal frequency hopping configuration to the user equipment. The system can, after the attaching with the user equipment, receive respective first sounding reference signal reports from the user equipment, wherein the respective first sounding reference signal reports are configured according to the first sounding reference signal frequency hopping configuration. The system can, in response to identifying that a power consumption of the user equipment satisfies a power limitation criterion, or that a user equipment channel condition satisfies a channel condition criterion, modify the first sounding reference signal frequency hopping configuration to a second sounding reference signal frequency hopping configuration, and communicate the second sounding reference signal frequency hopping configuration to the user equipment. The system can, after communicating the second sounding reference signal frequency hopping configuration to the user equipment, receive respective second sounding reference signal reports from the user equipment, wherein the respective second sounding reference signal reports are configured according to the second sounding reference signal frequency hopping configuration.

An example method can comprise communicating, by a system, a first sounding reference signal frequency hopping configuration to a user equipment as part of attaching to the user equipment. The method can further comprise, after the attaching with the user equipment, receiving, by the system, respective first sounding reference signal reports from the user equipment, wherein the respective first sounding reference signal reports are configured according to the first sounding reference signal frequency hopping configuration. The method can further comprise, in response to identifying that a power consumption of the user equipment satisfies a power limitation criterion, or that a user equipment channel condition satisfies a channel condition criterion, modifying, by the system, the first sounding reference signal frequency hopping configuration to a second sounding reference signal frequency hopping configuration, and communicating, by the system, the second sounding reference signal frequency hopping configuration to the user equipment. The method can further comprise, after communicating the second sounding reference signal frequency hopping configuration to the user equipment, receiving, by the system, respective second sounding reference signal reports from the user equipment, wherein the respective second sounding reference signal reports are configured according to the second sounding reference signal frequency hopping configuration.

An example non-transitory computer-readable medium can comprise instructions that, in response to execution, cause a system comprising a processor to perform operations. These operations can comprise communicating a first sounding reference signal frequency hopping configuration to a user equipment as part of attaching to the user equipment. These operations can further comprise, after the attaching, receiving respective first sounding reference signal reports from the user equipment, according to the first sounding reference signal frequency hopping configuration. These operations can further comprise, in response to identifying that the user equipment satisfies a criterion, communicating a second sounding reference signal frequency hopping configuration to the user equipment, wherein the second sounding reference signal frequency hopping configuration differs from the first sounding reference signal frequency hopping configuration. These operations can further comprise after communicating the second sounding reference signal frequency hopping configuration, receiving respective second sounding reference signal reports from the user equipment according to the second sounding reference signal frequency hopping configuration.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate dynamic selection of sounding reference signal frequency hopping configurations, in accordance with an embodiment of this disclosure;

FIG. 2 illustrates an example sounding reference signal configuration that can facilitate dynamic selection of sounding reference signal frequency hopping configurations, in accordance with an embodiment of this disclosure;

FIG. 3 illustrates an example medium access control control element for activation or deactivation of sounding reference signal frequency hopping, and that can facilitate dynamic selection of sounding reference signal frequency hopping configurations, in accordance with an embodiment of this disclosure;

FIG. 4 illustrates an example medium access control control element for activation or deactivation of sounding reference signal frequency hopping with a highest ServCellIndex of a serving cell that is less than 8, and that can facilitate dynamic selection of sounding reference signal frequency hopping configurations, in accordance with an embodiment of this disclosure;

FIG. 5 illustrates an example medium access control control element for activation or deactivation of sounding reference signal frequency hopping with a highest ServCellIndex of a serving cell that is 8 or more, and that can facilitate dynamic selection of sounding reference signal frequency hopping configurations, in accordance with an embodiment of this disclosure;

FIG. 6 illustrates an example feature set uplink information element that can facilitate dynamic selection of sounding reference signal frequency hopping configurations, in accordance with an embodiment of this disclosure;

FIG. 7 illustrates an example signal flow of using downlink control information to facilitate dynamic selection of sounding reference signal frequency hopping configurations, in accordance with an embodiment of this disclosure;

FIG. 8 illustrates a continuation of an example signal flow of using downlink control information to facilitate dynamic selection of sounding reference signal frequency hopping configurations, in accordance with an embodiment of this disclosure;

FIG. 9 illustrates a continuation of an example signal flow of using downlink control information to facilitate dynamic selection of sounding reference signal frequency hopping configurations, in accordance with an embodiment of this disclosure;

FIG. 10 illustrates a continuation of an example signal flow of using downlink control information to facilitate dynamic selection of sounding reference signal frequency hopping configurations, in accordance with an embodiment of this disclosure;

FIG. 11 illustrates an example signal flow of using a medium access control control element to facilitate dynamic selection of sounding reference signal frequency hopping configurations, in accordance with an embodiment of this disclosure;

FIG. 12 illustrates a continuation of an example signal flow of using a medium access control control element to facilitate dynamic selection of sounding reference signal frequency hopping configurations, in accordance with an embodiment of this disclosure;

FIG. 13 illustrates a continuation of an example signal flow of using a medium access control control element to facilitate dynamic selection of sounding reference signal frequency hopping configurations, in accordance with an embodiment of this disclosure;

FIG. 14 illustrates a continuation of an example signal flow of using a medium access control control element to facilitate dynamic selection of sounding reference signal frequency hopping configurations, in accordance with an embodiment of this disclosure;

FIG. 15 illustrates an example process flow that can facilitate dynamic selection of sounding reference signal frequency hopping configurations, in accordance with an embodiment of this disclosure;

FIG. 16 illustrates another example process flow that can facilitate dynamic selection of sounding reference signal frequency hopping configurations, in accordance with an embodiment of this disclosure;

FIG. 17 illustrates another example process flow that can facilitate dynamic selection of sounding reference signal frequency hopping configurations, in accordance with an embodiment of this disclosure;

FIG. 18 illustrates an example block diagram of a computer operable to execute an embodiment of this disclosure.

### DETAILED DESCRIPTION

### Overview

A Sounding Reference Signal (SRS) can be sent by user equipment (UE) according to instructions provided by a base station (e.g., a gNodeB, which can sometimes be referred to as a gNB). The SRS can be used by a gNB to measure an Uplink (UL) Channel propagation, and can be used by gNB for channel aware scheduling, Link Adaptation (LA), and Downlink (DL) channel estimation when channel reciprocity exists, such as in time division duplex (TDD) deployments.

A base station can configure frequency hopping parameters as a part of resourceMapping during a UE attach procedure. c-SRS (bandwidth configuration), b-SRS (bandwidth), and b-Hop (hopping bandwidth) configurations can indicate whether frequency hopping is configured as wide band or sub-band SRS reporting. The c-SRS, b-SRS, and b-Hop values can indicate a subband configuration for SRS reporting.

Where the UE is configured as wideband reporting using Layer 3 (L3) Radio Resource Control (RRC) signaling, and the UE is in a power limited situation, and/or the UE is not in good radio condition (e.g., −11 decibels (dB) for a signal-to-noise ratio (SNR)), a gNB can trigger a Downlink Control Information (DCI) and/or Medium Access Control Control Element (MAC-CE) message to change an SRS frequency hopping related configuration to modify sub-band reporting instead of wideband, and vice versa, to save on UE energy consumption, and facilitate better reception of an SRS report at a gNB side.

Prior approaches for changing the SRS frequency hopping parameters using L3 RRC signaling can be slower relative to the present techniques, and can also result in more radio resource usage (both for SRS frequency hopping until reconfiguration, as well as for signaling messages). Also, it can be that just to change the frequency hopping for SRS, which could need a few bits at the most, the gNB must transmit a whole RRC signaling message as currently defined by 3^{rd} Generation Partnership Project (3GPP) specifications.

The present techniques can be implemented to facilitate an efficient and faster method for changing an SRS frequency hopping configuration for SRS (as per UE conditions and other criteria) during periodic and semipersistent SRS transmission.

An SRS can comprise a reference signal for Uplink (that is, transmitted by UE), so that a gNB can perform channel quality estimation for Uplink.

SRSs can comprise Uplink physical signals that can be intended for channel sounding. SRSs can be used for:
Channel estimation of an Uplink at different frequency ranges,
Supporting UL channel-dependent scheduling and link adaptation,
Calculating UL timing advance for synchronization purposes,
UL antenna selection, precoding, multiple input and multiple output (MIMO) scheme, and UL rank selection,
DL MIMO, such as in in TDD and for multi-user MIMO (MU-MIMO), and
Carrier frequency offsets/Doppler shifts estimation

In some examples, the following steps can be performed for configuring an SRS to UE, and making use of the SRS report transmitted by the UE in deciding upon a configuration in subsequent scheduling of UL and DL data:
Step 1: RRC Configuration for SRS
Step 2: SRS transmission from UE
Step 3: SRS reception at gNB and Analysis
Step 4: Utilization of SRS by gNB

RRC configuration for SRS can be implemented as follows. During a UE attach procedure, a base station can determine an SRS configuration (e.g., SRS physical resources, frequency hopping, usage, report period timing, etc.), and notify the configuration to the UE via RRC messages (e.g., RRCSetup, RRCReconfiguration, as described herein).

SRS configuration from UE can be implemented as follows. The UE can transmit the SRS, which can be a predefined signal with known characteristics, at a specific time and frequency. The SRS configuration can be provided to the UE by the gNB, and it can vary depending on the cell's conditions and traffic requirements. The UE can send the SRS periodically or aperiodically, as instructed by the gNB, on the UL channel.

A gNB can configure the UE to transmit the SRS across the full band at once, or can configure UE to transmit the SRS for a certain segment of the frequency band using the parameter SRS-Resource.freqHopping.

SRS reception at gNB and analysis can be performed as follows. Upon receiving the SRS from the UE, the gNB can measure and analyze the received signal. The gNB can estimate the channel state information (CSI) by comparing the received SRS with a known reference signal. The gNB can evaluate various parameters, such as the path loss, propagation delay (phase delay), and received signal strength, to understand the current radio environment and channel conditions between the gNB and the UE.

Utilization of SRS by gNB can be performed as follows. Once the gNB has estimated the channel state based on the SRS, it can use this information to optimize its resource allocation and scheduling decisions.

### EXAMPLE ARCHITECTURES, GRAPHS, ETC

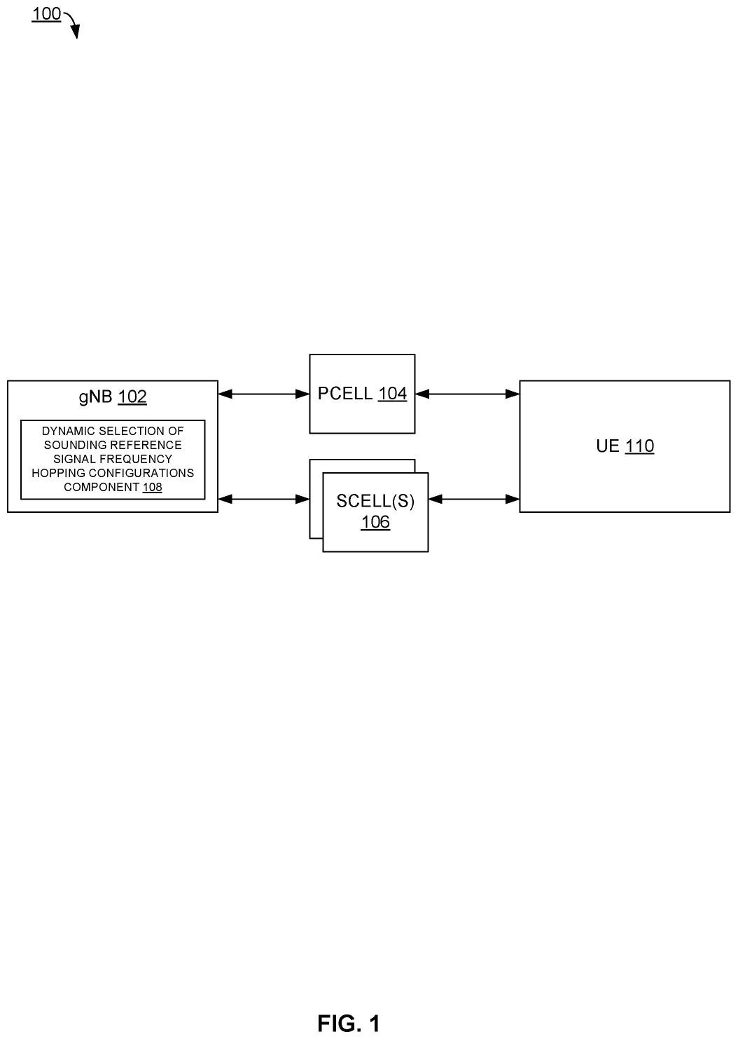

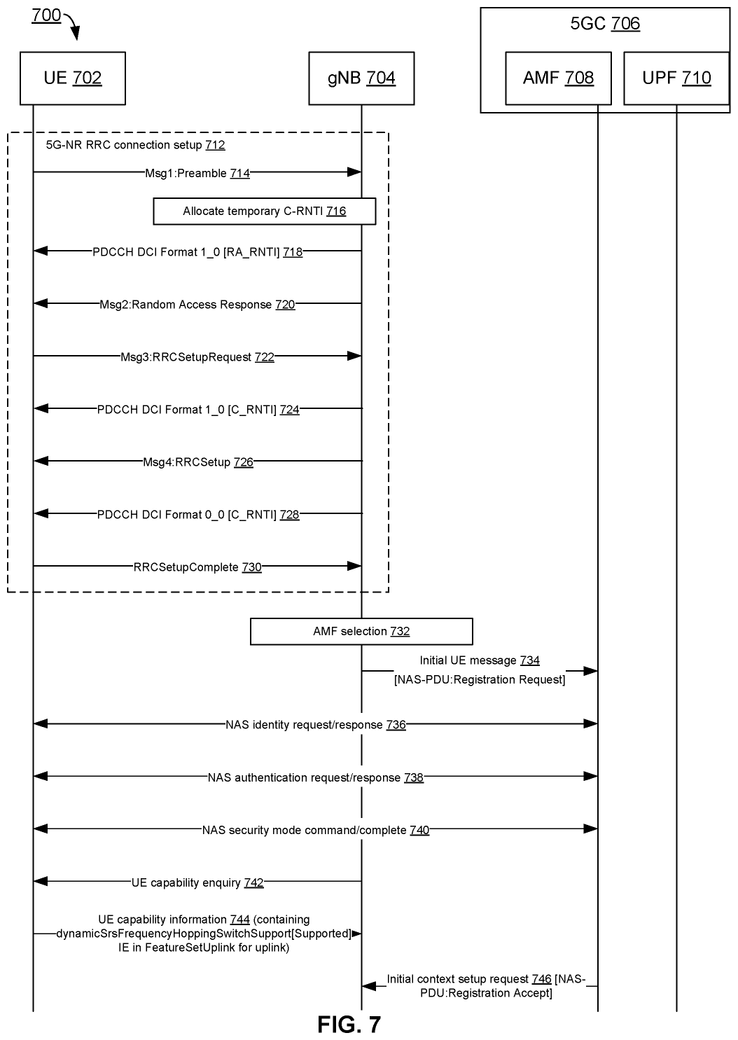

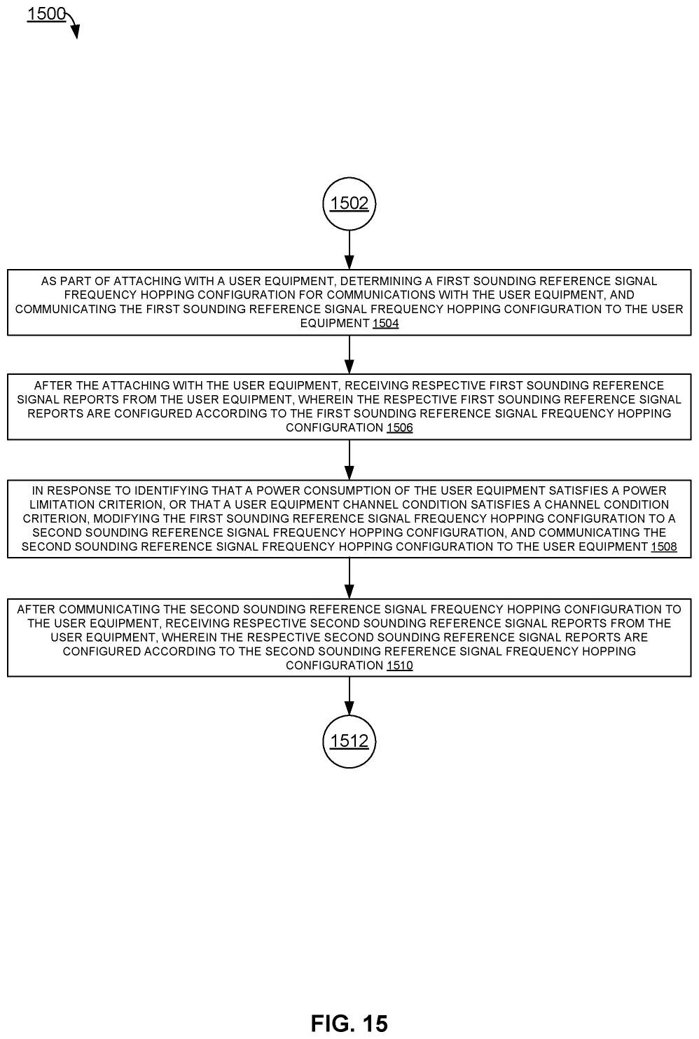

FIG. 1 illustrates an example system architecture 100 that can facilitate dynamic selection of sounding reference signal frequency hopping configurations in accordance with an embodiment of this disclosure. In some examples, part(s) of system architecture 100 can be used to implement the example signal flows of FIGS. 7-14, and/or the example process flows of FIGS. 15-17.

In cellular communications, there can be a master cell group (MCG) to which a UE initially registers. A cell that is used to initiate initial access can be referred to as a primary cell (Pcell). A Pcell can be combined with one or more secondary cells (Scells) under an MCG using carrier aggregation techniques, which can generally involve combining multiple carriers to increase bandwidth available to UEs.

The examples herein generally relate to 5G cellular communications networks, where Pcells and Scells are used. It can be appreciated that the present techniques can be applied to other types of cellular communications networks for SRS transmission optimization.

As depicted, system architecture 100 comprises gNodeB (gNB) 102, Pcell 104, Scell(s) 106, dynamic selection of sounding reference signal frequency hopping configurations component 108, and UE 110

gNB 102 can generally comprise a cellular fifth-generation (5G) base station, can comprise multiple antennas, and can concurrently communicate with multiple instances of UE 110. UE 110 can generally comprise a computing device that is configured to be used directly by an end-user to communicate with gNB 102. Pcell 104 can be a Pcell as described herein, and that is communicatively coupled to both gNB 102 and UE 110. Similarly, Scell(s) 106 can be one or more Scells as described herein, and that are communicatively coupled to both gNB 102 and UE 110.

Dynamic selection of sounding reference signal frequency hopping configurations component 108 can generally comprise a component of gNB 102 that facilitates dynamic selection of sounding reference signal frequency hopping configurations for gNB 102 as described herein.

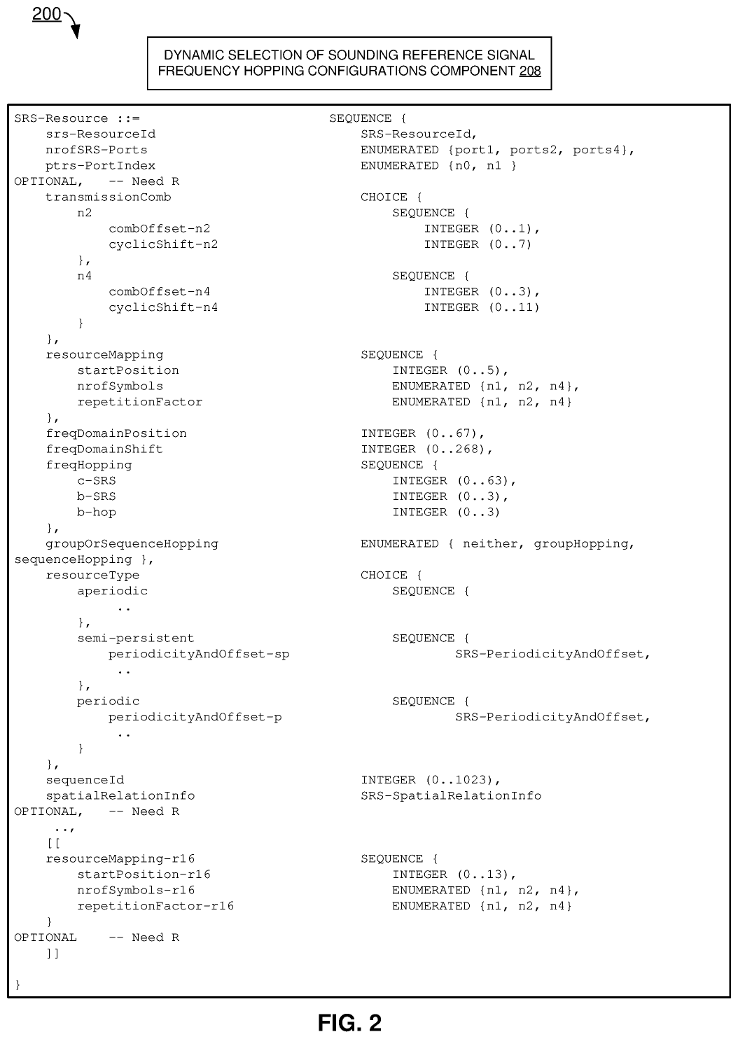

FIG. 2 illustrates an example sounding reference signal configuration 200 that can facilitate dynamic selection of sounding reference signal frequency hopping configurations, in accordance with an embodiment of this disclosure. In some examples, part(s) of sounding reference signal configuration 200 can be implemented by part(s) of system architecture 100 of FIG. 1 to facilitate dynamic selection of sounding reference signal frequency hopping configurations.

Also depicted is dynamic selection of sounding reference signal frequency hopping configurations component 208 (which can be similar to dynamic selection of sounding reference signal frequency hopping configurations component 108 of FIG. 1), and which can utilize information in sounding reference signal configuration 200.

In sounding reference signal configuration 200, the following can establish an SRS frequency hopping configuration:

| | |
|---|---|
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |
| }, | |

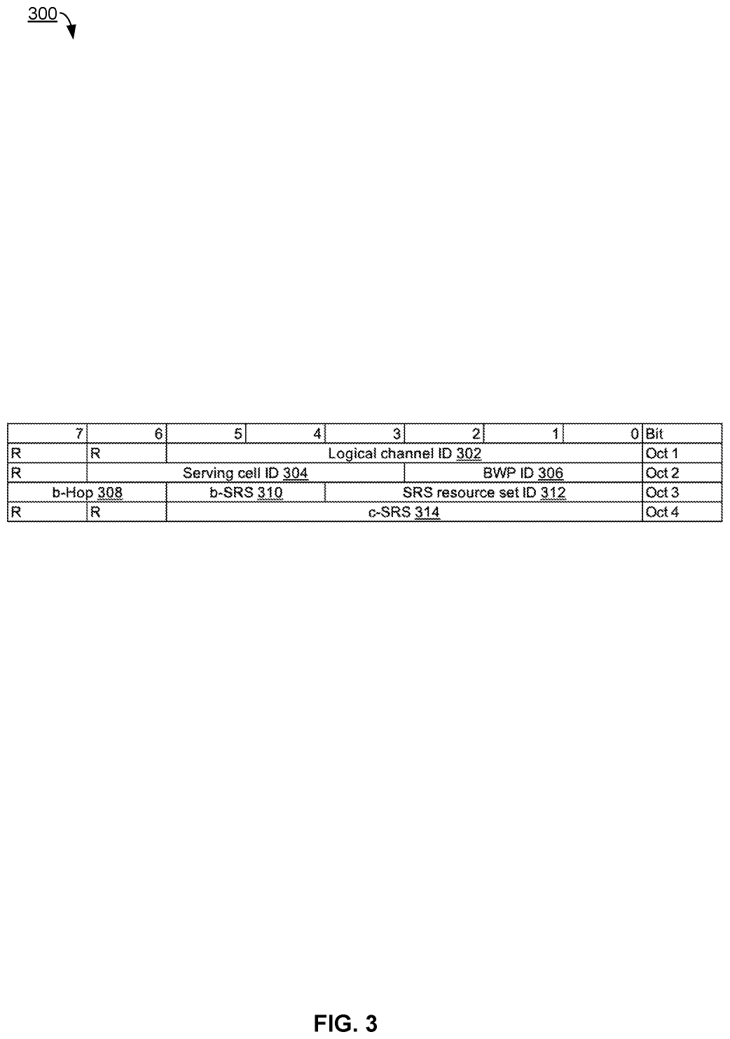

FIG. 3 illustrates an example medium access control control element 300 for activation or deactivation of sounding reference signal frequency hopping, and that can facilitate dynamic selection of sounding reference signal frequency hopping configurations, in accordance with an embodiment of this disclosure. In some examples, part(s) of medium access control control element 300 can be implemented by part(s) of system architecture 100 of FIG. 1 to facilitate dynamic selection of sounding reference signal frequency hopping configurations.

Medium access control control element 300 comprises logical channel ID 302, serving cell ID 304, bandwidth part (BWP) ID 306, b-Hop 308, b-SRS 310, SRS resource set ID 312, and c-SRS 314.

A problem associated with SRS frequency hopping configurations can be that, when a UE is in a limited power condition, or the UE is not able to measure channel condition for complete bandwidth, it can be that the UE must scan complete bandwidth and send the SRS report to a gNB, because the gNB has provided the configuration to measure the complete bandwidth during an attach procedure. By doing that, the UE's battery can drain quickly. In this case, it can be that the gNB must perform a procedure so that UE can save the energy.

The present techniques can be implemented to mitigate against this problem by changing SRS-Resource.freqHopping parameters dynamically to measure a sub-band instead of the full band.

Another problem with SRS frequency hopping configurations can relate to a high speed mobility (handover) scenario. When a UE is in a high mobility scenario, channel/radio condition can frequently vary, so it can be that measuring and estimating channel quality for the SRS full band can be difficult for the UE.

The present techniques can be implemented to mitigate this problem by changing the configuration so that the UE measures the sub band instead of the full band, and reports to the gNB based on the sub band measurements.

Another problem with SRS frequency hopping configurations can relate to when a UE is at a cell edge. When the UE is at the cell edge, it can be that the channel quality of the UE is not at its best, and measuring and reporting the complete bandwidth (full band) instead of the sub band can be a challenge.

The present techniques can be implemented to mitigate against this problem by the gNB changing the configuration dynamically so that the UE measures the sub band instead of the full band, and vice versa.

In a period trigger or aperiodic trigger case, once an SRS-Resource set configuration is received in a RRC message, it can be that there is not an efficient and dynamic mechanism using Layer 1 (DCI) or Layer 2 (MAC-CE) signaling to change frequency hopping-related parameters, as per existing 3GPP specifications. It can be that the only way to accomplish this is for a gNB to trigger RRC signaling, which can be slower relative to DCI or MAC-CE messaging, and can consume more radio resources relative to those approaches (so can be overkill to change frequency hopping (wideband and sub band) related configurations for SRS transmissions). If the UE radiofrequency (RF) condition changes from good to bad, or vice versa, and if the gNB wants to adapt the SRS transmission accordingly to reduce UE energy consumption and avoid the UE draining its battery, then there can be a problem that prior approaches lack an efficient and/or fast mechanism to accomplish this.

According to the present techniques following approaches can be implemented to mitigate against these problems.

One approach according to the present techniques can involve implementing a new MAC-CE: “Activation/Deactivation of SRS Frequency Hopping.” When the UE is in a power-limited situation, or UE channel condition is not good enough to perform wideband scanning that is configured during a UE attach procedure, the gNB can trigger this MAC-CE to modify the frequency hopping related configuration so that the UE can measure sub band instead of wide band, and vice versa.

In this MAC-CE, the Activation/Deactivation of SRS Frequency Hopping using MAC-CE can be identified by a MAC sub header with a Logical Channel ID (LCID) as shown in FIG. 3. This MAC-CE can have a fixed size of 32 bits, with the following fields:
Serving Cell ID: This field can indicate an identity of the Serving Cell, which contains an activated SRS Resource Set. The length of the field can be 5 bits.
Bandwidth Part (BWP) ID: This field can indicate a UL BWP as a codepoint of the DCI bandwidth part indicator field, which can contain an activated SRS Resource Set. The length of the field can be 2 bits.
SRS Resource Set ID: This field can indicate the SRS Resource Set ID identified by SRS-ResourceSetId. The length of this field can be 4 bits.
b-SRS: Bₛᵣₛ∈{0,1,2,3} can be given by the field b-SRS contained in a higher-layer parameter freqHopping, if configured, and otherwise B_{SRS}=0.
C-SRS: The row of the table can be selected according to the index C_{SRS} € {0,1, . . . , 63} given by the field c-SRS contained in the higher-layer parameter freqHopping.
b-hop: Frequency hopping of the sounding reference signal can be configured by the parameter bₕₒₚ ∈{0,1,2,3}, given by the field b-hop contained in the higher-layer parameter freqHopping if configured, and otherwise bₕₒₚ=0.
R: Reserved bit, which can be set to 0.

In some examples, other SRS resource configurations can remain the same as RRC (L3) signaling specified; and it can be that only frequency hopping parameters are changed by this MAC-CE based on the gNB determination.

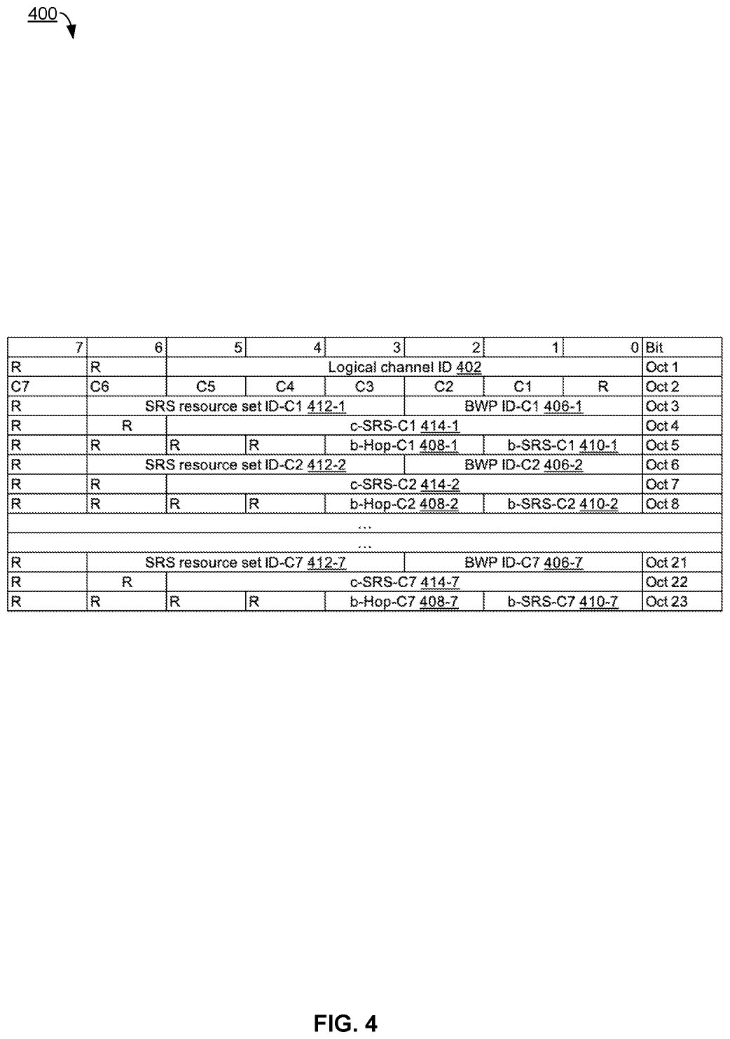

FIG. 4 illustrates an example medium access control control element 400 for activation or deactivation of sounding reference signal frequency hopping with a highest ServCellIndex of a serving cell that is less than 8, and that can facilitate dynamic selection of sounding reference signal frequency hopping configurations, in accordance with an embodiment of this disclosure. In some examples, part(s) of medium access control control element 400 can be implemented by part(s) of system architecture 100 of FIG. 1 to facilitate dynamic selection of sounding reference signal frequency hopping configurations.

Medium access control control element 400 comprises logical channel ID 402, BWP ID-C1 406-1, b-Hop-C1 408-1, b-SRS-C1 410-1, SRS resource set ID-C1 412-1, c-SRS-C1 414-1, BWP ID-C2 406-2, b-Hop-C2 408-2, b-SRS-C2 410-2, SRS resource set ID-C2 412-2, c-SRS-C2 414-2, BWP ID-C7 406-7, b-Hop-C7 408-7, b-SRS-C7 410-7, SRS resource set ID-C7 412-7, and c-SRS-C7 414-7.

One approach according to the present techniques can involve implementing a new MAC-CE “Activation/Deactivation of SRS Frequency Hopping using MAC CE with the highest ServCellIndex of Serving Cell is less than 8.” Once the UE has secondary cells activated and the SRS configuration is configured by gNB to the UE for each serving cell, then UE can start reporting the SRS based on an L3 RRC configuration.

If one or more serving cells are experiencing a power-limited situation, or cell edge situation, then the gNB can trigger this MAC-CE and change the frequency hopping configuration, while the rest of the configuration can remain same as communicated to UE through L3 RRC signaling.

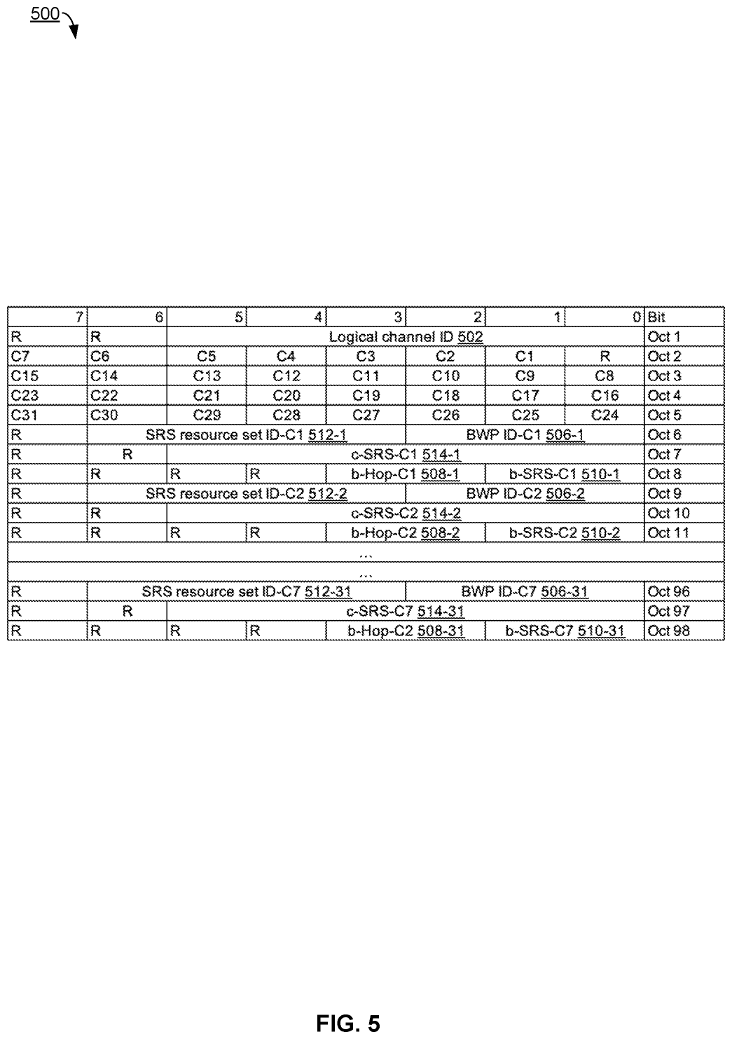

In this MAC-CE, the Activation/Deactivation of SRS Frequency Hopping using MAC CE with the highest ServCellIndex of Serving Cell is less than 8 can identified by a MAC sub header with LCID as specified in FIG. 5. This MAC-CE can have a variable size, with the following fields:
BWP ID_{Ci}: This field can indicate a UL BWP for each secondary cell as the codepoint of a DCI bandwidth part indicator field, which contains activated SRS Resource Set. The length of the field can be 2 bits.
SRS Resource Set ID_{Ci}: This field can indicate the SRS Resource Set ID for each secondary cell as identified by SRS-ResourceSetId. The length of the field can be 4 bits.
b-SRS_{Ci}: Bₛᵣₛ E {0,1,2,3} can be given by the field b-SRS contained in the higher-layer parameter freqHopping if configured, and otherwise B_{SRS}=0 for each secondary cells.
C-SRS_{Ci}: The row of the table can be selected according to the index C_{SRS} € {0,1, . . . , 63} given by the field c-SRS contained in the higher-layer parameter freqHopping for each secondary cells.
b-hop_{Ci}: Frequency hopping of the SRS can be configured by the parameter bₕₒₚ E {0,1,2,3}, given by the field b-hop contained in the higher-layer parameter freqHopping if configured, and otherwise bₕₒₚ=0 for each secondary cell.
R: Reserved bit, which can be set to 0.

FIG. 5 illustrates an example medium access control control element 500 for activation or deactivation of sounding reference signal frequency hopping with a highest ServCellIndex of a serving cell that is 8 or more, and that can facilitate dynamic selection of sounding reference signal frequency hopping configurations, in accordance with an embodiment of this disclosure. In some examples, part(s) of medium access control control element 500 can be implemented by part(s) of system architecture 100 of FIG. 1 to facilitate dynamic selection of sounding reference signal frequency hopping configurations.

Medium access control control element 500 comprises logical channel ID 502, BWP ID-C1 506-1, b-Hop-C1 508-1, b-SRS-C1 510-1, SRS resource set ID-C1 512-1, c-SRS-C1 514-1, BWP ID-C2 506-2, b-Hop-C2 508-2, b-SRS-C2 510-2, SRS resource set ID-C2 512-2, c-SRS-C2 514-2, BWP ID-C31 506-31, b-Hop-C31 508-31, b-SRS-C31 510-31, SRS resource set ID-C31 512-31, and c-SRS-C31 514-31.

One approach according to the present techniques can involve implementing a new MAC-CE “Activation/Deactivation of SRS Frequency Hopping using MAC CE with the highest ServCellIndex of Serving Cell is greater than 8.” The fields can be similar to the MAC-CE “Activation/Deactivation of SRS Frequency Hopping using MAC CE with the highest ServCellIndex of Serving Cell is less than 8.”

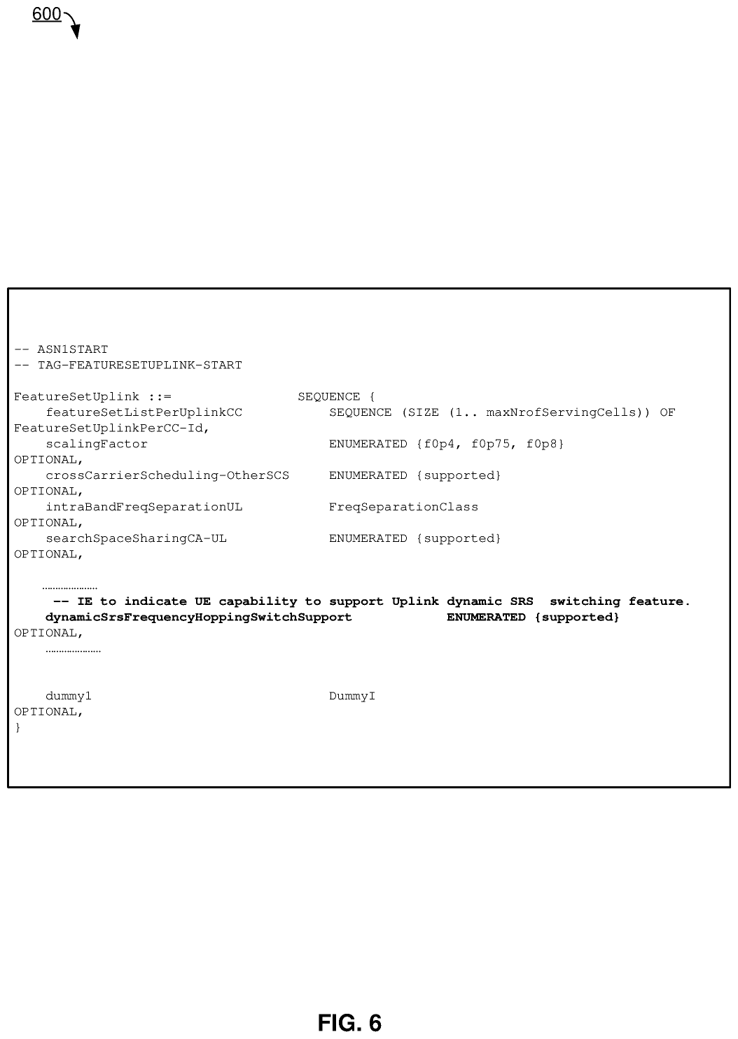

FIG. 6 illustrates an example feature set uplink information element 600 that can facilitate dynamic selection of sounding reference signal frequency hopping configurations, in accordance with an embodiment of this disclosure. In some examples, part(s) of feature set uplink information element 600 can be implemented by part(s) of system architecture 100 of FIG. 1 to facilitate dynamic selection of sounding reference signal frequency hopping configurations.

One approach according to the present techniques can involve implementing new fields in UL DCI 0_1 format and DL DCI 1_1 format. Where a gNB changes a frequency hopping related configuration, it can send the new configuration to a UE using DL and UL DCI formats. DCI can be communicated from a MAC layer of a gNB to a MAC layer of a UE.
The following parameters can be added to DL DCI 1_1 and UL DCI 0_1:
b-SRS: Bₛᵣₛ ∈{0,1,2,3} can be given by the field b-SRS contained in the higher-layer parameter freqHopping if configured, and otherwise B_{SRS}=0.
c-SRS: The row of the table can be selected according to the index C_{SRS} ∈{0,1, . . . , 63} given by the field c-SRS contained in the higher-layer parameter freqHopping.
b-hop: Frequency hopping of the sounding reference signal can be configured by the parameter bₕₒₚ ∈{0,1,2,3}, given by the field b-hop contained in the higher-layer parameter freqHopping if configured, and otherwise bₕₒₚ=0.

The present techniques can be implemented to facilitate an information element (IE) in UE capability to support dynamic switching of an SRS frequency hopping configuration. According to this approach, an IE dynamicSrsFrequencyHoppingSwitchSupport can be implemented for uplink in FeatureSetUplink. If a UE supports this IE this can mean that the UE will support dynamic SRS symbol switch configuration change in the uplink direction.

An IE FeatureSetUplink can be used to indicate the features that the UE supports on the carriers corresponding to one band entry in a band combination.

With a dynamicSrsFrequencyHoppingSwitchSupport IE, A UE can set this field to support if UE is capable of supporting uplink dynamic SRS symbol switch features.

A UE can be capable of handling the newly introduced DCI fields for uplink/downlink DCI format 0_1/1_1, as described above. A UE can be capable of handling the MAC-CE “Activation/Deactivation of SRS Frequency Hopping using MAC-CE.” A UE can be capable of handling the MAC-CE “Activation/Deactivation of SRS Frequency Hopping using MAC CE with the highest ServCellIndex of Serving Cell is less than 8.” A UE can be capable of handling a MAC-CE “Activation/Deactivation of SRS Frequency Hopping using MAC CE with the highest ServCellIndex of Serving Cell is greater than 8.”

Conditions to trigger to modify frequency hopping related configuration of SRS via MAC CE and/or DCI can be implemented as follows. A gNB can instruct the UE to adopt new frequency hopping related configuration of SRS based on the following conditions:
When the UE is in a power limited state, this can indicate that the UE does not have the sufficient power to scan the complete bandwidth. In that case gNB-measured signal-to-interference-plus-noise ratio (SINR) can be below a certain threshold for SRS report and or Physical Uplink Shared Channel/Physical Uplink Control Channel (PUSCH/PUCCH) cyclic redundancy check (CRC) indication by UE. In that case, the gNB can trigger the frequency hopping related configuration via DCI and/or MAC-CE to configure the sub-band scanning and reporting.
When the UE is in good condition and the UE has sufficient power to scan the complete bandwidth.
When the UE is in good RF conditions and measured SINR is higher than a certain threshold (and other indicators reported like Channel-Quality Indicator (CQI) and/or Block-Error Rate (BLER) point to good radio conditions), then the gNB can instruct the UE, through DCI and/or MAC CE to decrease the number of SRS symbols. For example, the number of SRS symbols can be decreased from 4 to 2, from 4 to 1, or from 2 to 1 (depending on different SINR thresholds).
When the UE is in bad RF conditions and measured SINR is lower than a certain threshold (and other indicators reported like CQI, BLER point to poor radio conditions), then the gNB can instruct the UE, through DCI and/or MAC CE, to increase the number of SRS symbols. Fox example, the number of SRS symbols can be increased from 2 to 4, from 1 to 4, or from 1 to 2 (depending on different SINR thresholds).
When the UE is in fast-changing radio conditions (example mobile scenarios), then the gNB can instruct the UE, through DCI and/or MAC CE, to increase or decrease the number of SRS symbols depending on measured SINR thresholds (and other indicators like CQI and BLER).

FIG. 7 illustrates an example signal flow 700 of using downlink control information to facilitate dynamic selection of sounding reference signal frequency hopping configurations, in accordance with an embodiment of this disclosure. In some examples, part(s) of signal flow 700 can be implemented by part(s) of system architecture 100 of FIG. 1 to facilitate dynamic selection of sounding reference signal frequency hopping configurations.

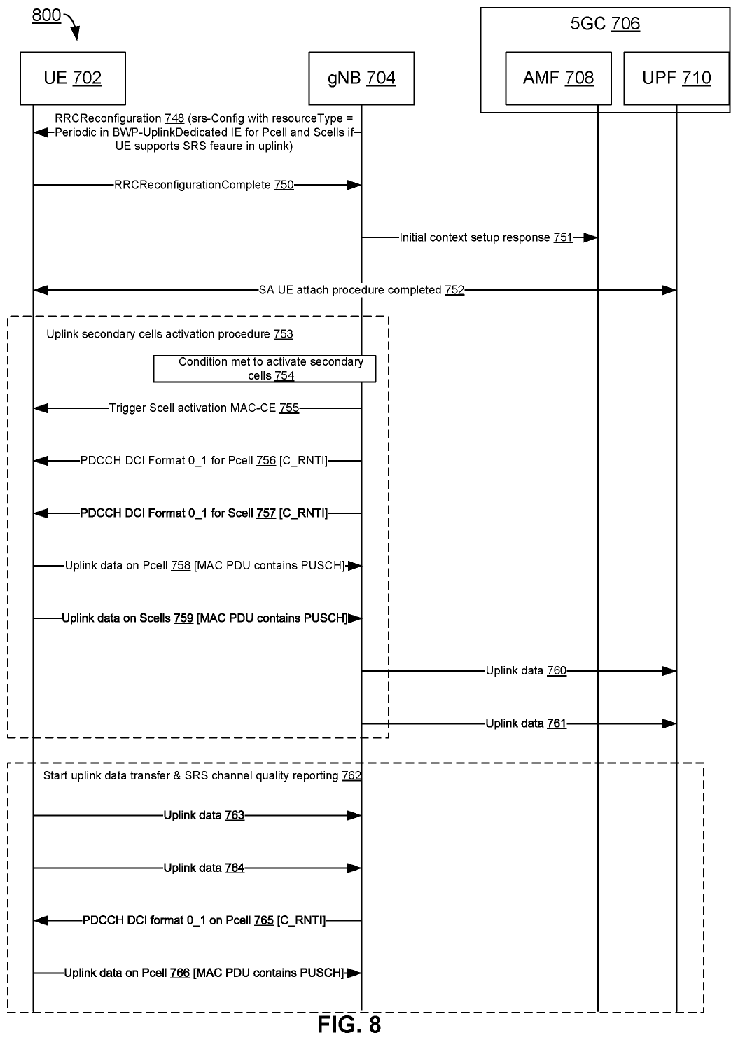

FIG. 8 illustrates a continuation of an example signal flow 800 of using downlink control information to facilitate dynamic selection of sounding reference signal frequency hopping configurations, in accordance with an embodiment of this disclosure. In some examples, part(s) of signal flow 800 can be implemented by part(s) of system architecture 100 of FIG. 1 to facilitate dynamic selection of sounding reference signal frequency hopping configurations.

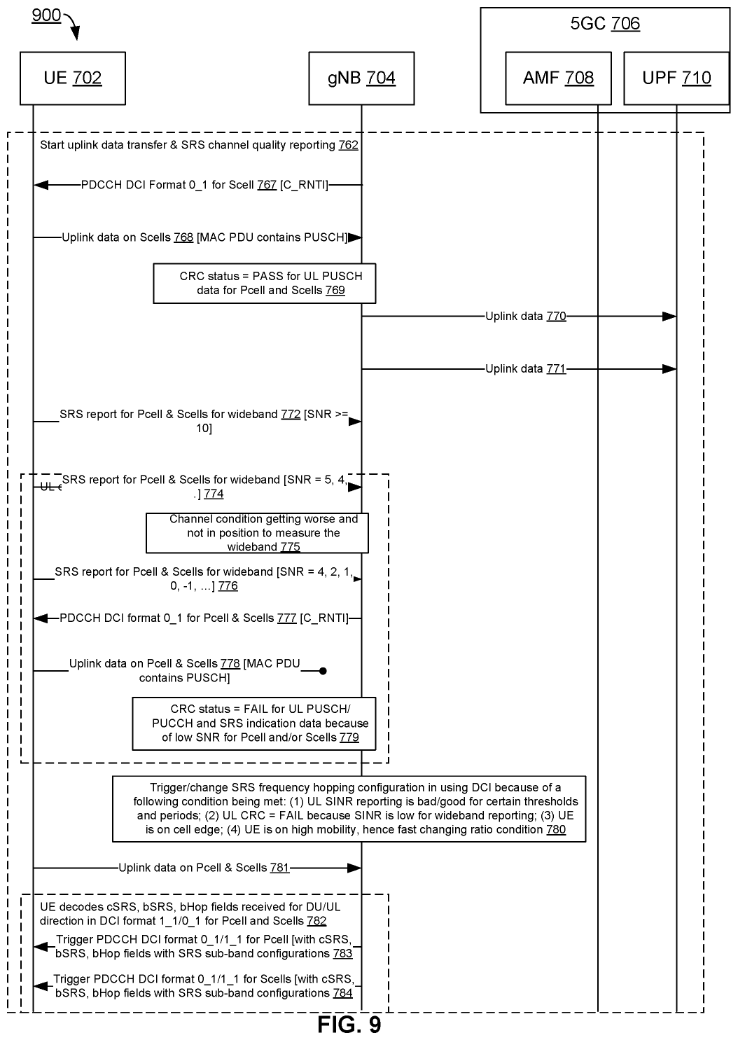

FIG. 9 illustrates a continuation of an example signal flow 900 of using downlink control information to facilitate dynamic selection of sounding reference signal frequency hopping configurations, in accordance with an embodiment of this disclosure. In some examples, part(s) of signal flow 900 can be implemented by part(s) of system architecture 100 of FIG. 1 to facilitate dynamic selection of sounding reference signal frequency hopping configurations.

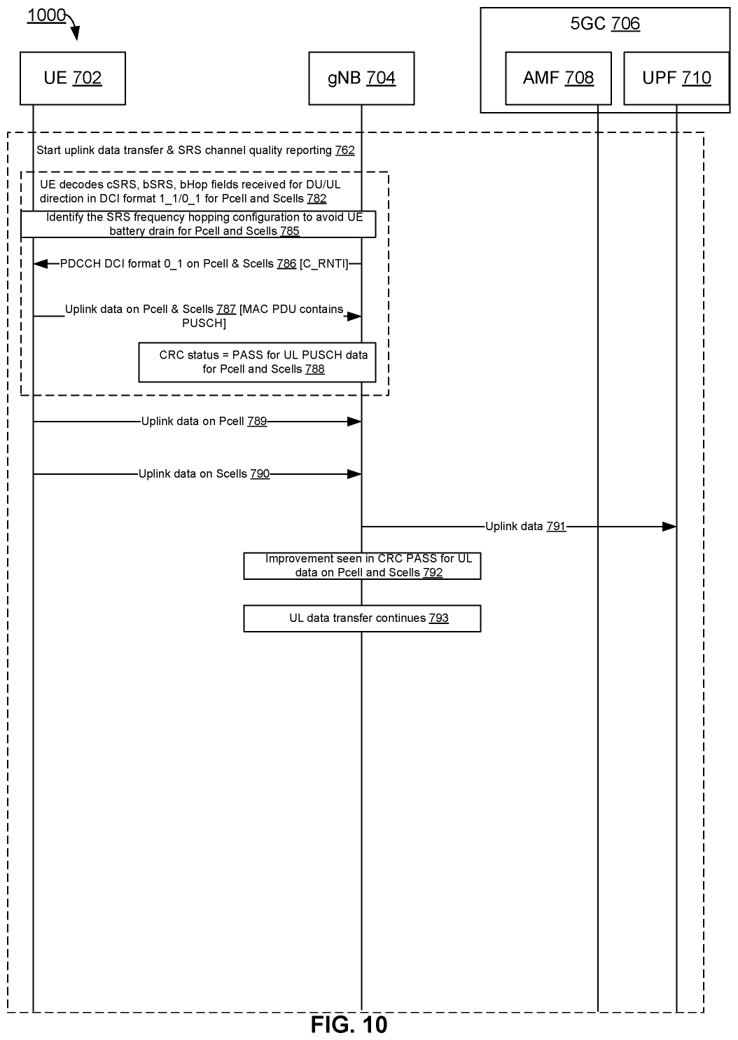

FIG. 10 illustrates a continuation of an example signal flow 1000 of using downlink control information to facilitate dynamic selection of sounding reference signal frequency hopping configurations, in accordance with an embodiment of this disclosure. In some examples, part(s) of signal flow 1000 can be implemented by part(s) of system architecture 100 of FIG. 1 to facilitate dynamic selection of sounding reference signal frequency hopping configurations.

As depicted, in signal flow 700, 800, 900, and 1000, communications are sent between UE 702, gNB 704, and 5G core (5GC) 706 (which comprises access and mobility management function (AMF) 708 and user plane function (UPF) 710).

The signal flow of signal flow 700, 800, 900, and 1000 is an example signal flow, and there can be signal flows that implement different signals, or the signals of signal flow 700 and 800 in a different order, as part of facilitating detecting unresponsive user equipment.

As depicted in signal flow 700 and 800, the following occurs:
5G-NR RRC connection setup 712
Msg1: Preamble 714
Allocate temporary cell radio-network temporary identifier (C-RNTI) 716
Physical downlink control channel (PDCCH) downlink control information (DCI)
Format 1_0 [random access radio network temporary identifier (RA_RNTI)] 718
Msg2: Random Access Response 720
Msg3: RRCSetupRequest 722
PDCCH DCI Format 1_0 [C_RNTI] 724
Msg4: RRCSetup 726
PDCCH DCI Format 0_0 [C_RNTI] 728
RRCSetupComplete 730
AMF selection 732
Initial UE message 734 [non-access-stratum-protocol data unit (NAS-PDU): Registration Request]
NAS identity request/response 736
NAS authentication request/response 738
NAS security mode command/complete 740
UE capability enquiry 742
UE capability information 744 (containing dynamicSrsFrequencyHoppingSwitchSupport [Supported] IE in FeatureSetUplink for uplink)· Initial context setup request 746 [NAS-PDU: Registration Accept]
RRCReconfiguration 748 (srs-Config with resourceType=Periodic in BWP-UplinkDedicated IE for Pcell and Scells if UE supports SRS feature in uplink)·
RRCReconfigurationComplete 750
Initial context setup response 751
SA UE attach procedure completed 752
Uplink secondary cells activation procedure 753
Condition met to activate secondary cells 754
Trigger Scell activation MAC-CE 755
PDCCH DCI Format 0_1 for Pcell 756 [C_RNTI]
PDCCH DCI Format 0_1 for Scell 757 [C_RNTI]
Uplink data on Pcell 758 [MAC PDU contains PUSCH]
Uplink data on Scells 759 [MAC PDU contains PUSCH]
Uplink data 760
Uplink data 761
Start uplink data transfer & SRS channel quality reporting 762
Uplink data 763
Uplink data 764.
PDCCH DCI format 0_1 on Pcell 765 [C_RNTI]
Uplink data on Pcell 766 [MAC PDU contains PUSCH]
PDCCH DCI Format 0_1 for Scell 767 [C_RNTI]
Uplink data on Scells 768 [MAC PDU contains PUSCH]
CRC status=PASS for UL PUSCH data for Pcell and Scells 769
Uplink data 770
Uplink data 771
SRS report for Pcell & Scells for wideband 772 [SNR>=10]
UL data decoding failed at gNB for Pcell and/or Scells 773.
SRS report for Pcell & Scells for wideband [SNR=5, 4, . . . ] 774
Channel condition getting worse and not in position to measure the wideband 775.
SRS report for Pcell & Scells for wideband [SNR=4, 2, 1, 0, −1, . . . ] 776
PDCCH DCI format 0_1 for Pcell & Scells 777 [C_RNTI]
Uplink data on Pcell & Scells 778 [MAC PDU contains PUSCH]
CRC status=FAIL for UL PUSCH/PUCCH and SRS indication data because of low SNR for Pcell and/or Scells 779
Trigger/change SRS frequency hopping configuration in using DCI because of a following condition being met: (1) UL SINR reporting is bad/good for certain thresholds and periods; (2) UL CRC=FAIL because SINR is low for wideband reporting; (3) UE is on cell edge; (4) UE is on high mobility, hence fast changing ratio condition 780
Uplink data on Pcell & Scells 781
UE decodes cSRS, bSRS, bHop fields received for DU/UL direction in DCI format 1_1/0_1 for Pcell and Scells 782
Trigger PDCCH DCI format 0_1/1_1 for Pcell [with cSRS, bSRS, bHop fields with SRS sub-band configurations 783
Trigger PDCCH DCI format 0_1/1_1 for Scells [with cSRS, bSRS, bHop fields with SRS sub-band configurations 784
Identify the SRS frequency hopping configuration to avoid UE battery drain for Pcell and Scells 785
PDCCH DCI format 0_1 on Pcell & Scells 786 [C_RNTI]
Uplink data on Pcell & Scells 787 [MAC PDU contains PUSCH]
CRC status=PASS for UL PUSCH data for Pcell and Scells 788
Uplink data on Pcell 789
Uplink data on Scells 790
Uplink data 791
Improvement seen in CRC PASS for UL data on Pcell and Scells 792
UL data transfer continues 793

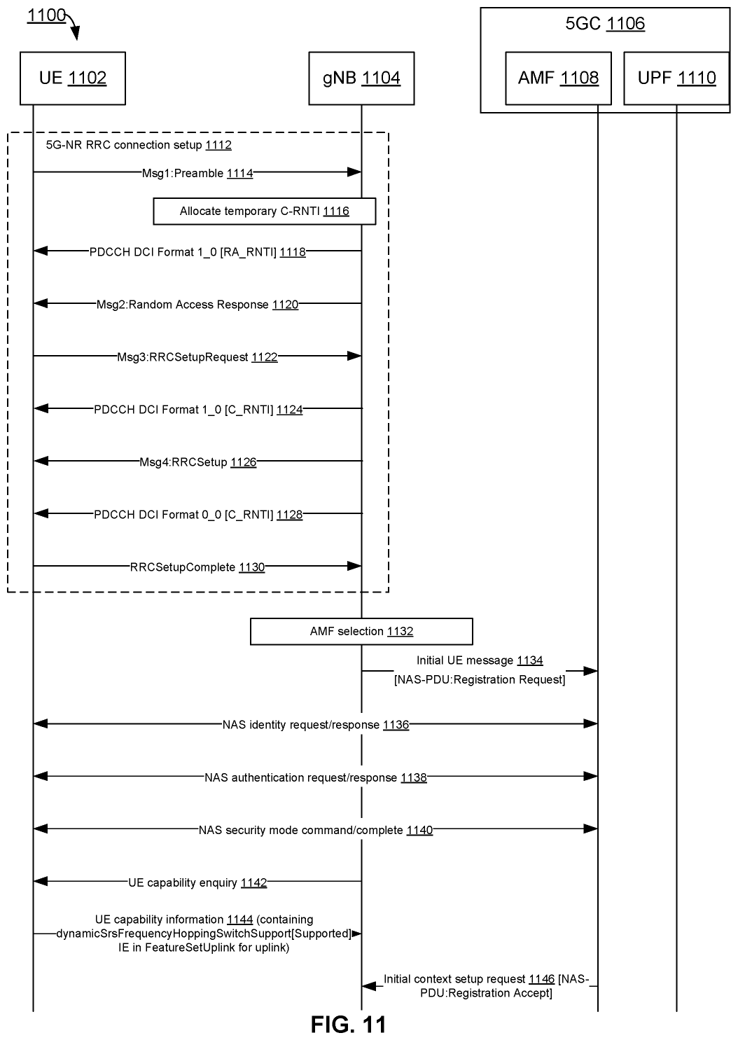

FIG. 11 illustrates an example signal flow 1100 of using a medium access control control element to facilitate dynamic selection of sounding reference signal frequency hopping configurations, in accordance with an embodiment of this disclosure. In some examples, part(s) of signal flow 1100 can be implemented by part(s) of system architecture 100 of FIG. 1 to facilitate dynamic selection of sounding reference signal frequency hopping configurations.

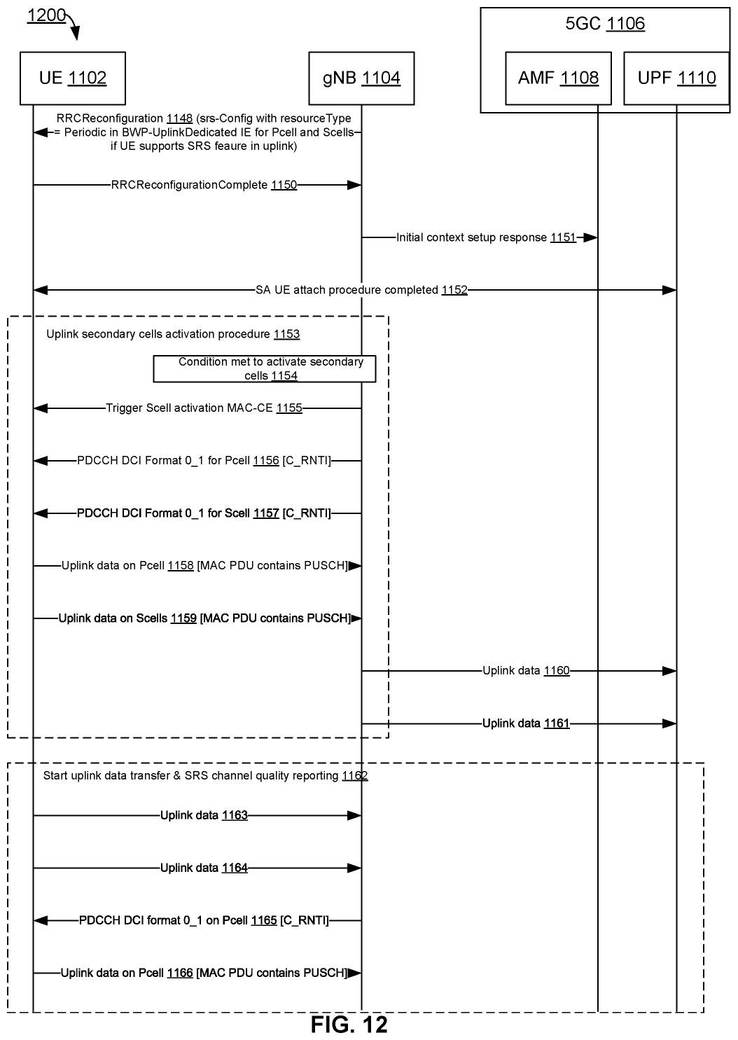

FIG. 12 illustrates a continuation of an example signal flow 1200 of using a medium access control control element to facilitate dynamic selection of sounding reference signal frequency hopping configurations, in accordance with an embodiment of this disclosure. In some examples, part(s) of signal flow 1200 can be implemented by part(s) of system architecture 100 of FIG. 1 to facilitate dynamic selection of sounding reference signal frequency hopping configurations.

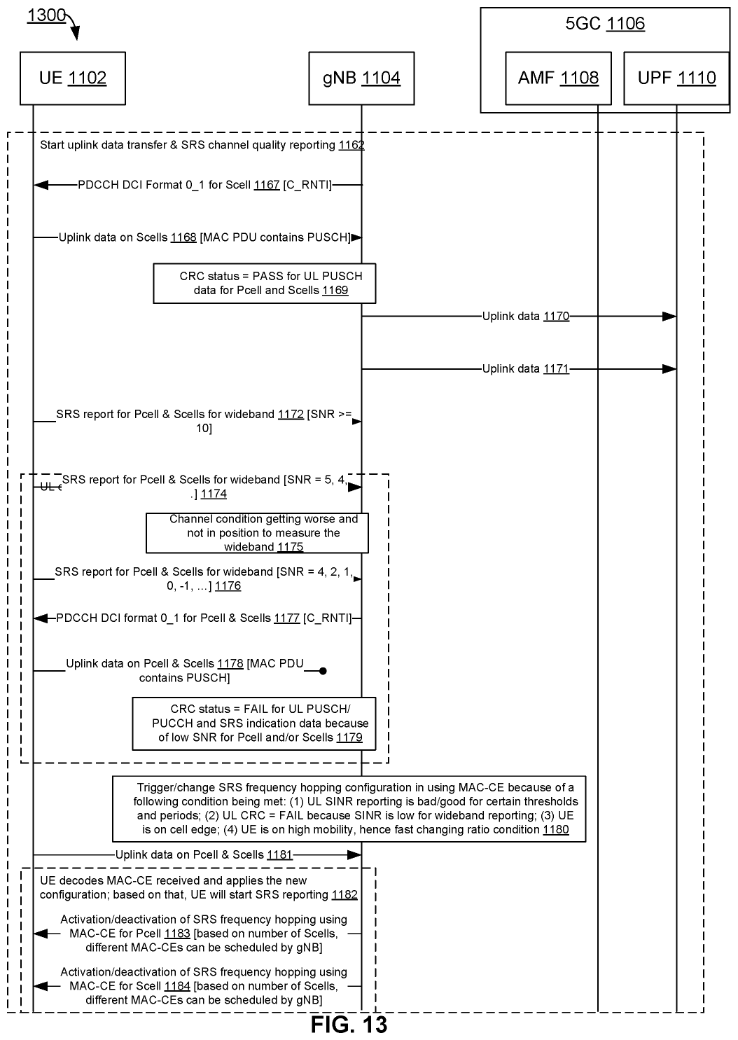

FIG. 13 illustrates a continuation of an example signal flow 1300 of using a medium access control control element to facilitate dynamic selection of sounding reference signal frequency hopping configurations, in accordance with an embodiment of this disclosure. In some examples, part(s) of signal flow 1300 can be implemented by part(s) of system architecture 100 of FIG. 1 to facilitate dynamic selection of sounding reference signal frequency hopping configurations.

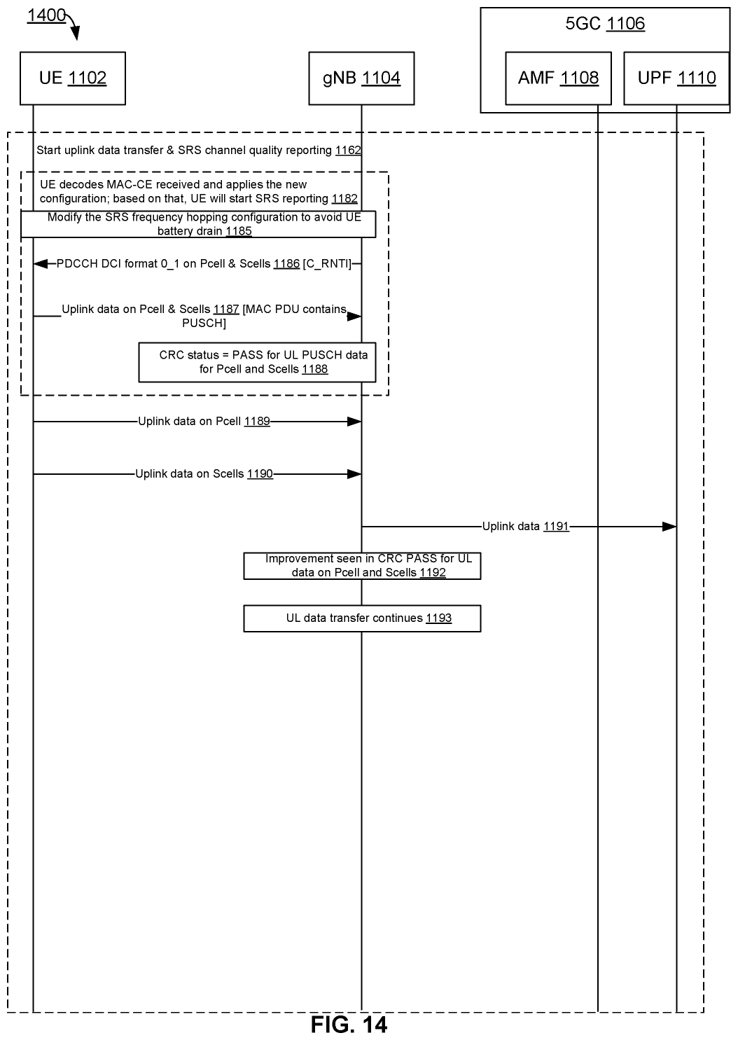

FIG. 14 illustrates a continuation of an example signal flow 1400 of using a medium access control control element to facilitate dynamic selection of sounding reference signal frequency hopping configurations, in accordance with an embodiment of this disclosure. In some examples, part(s) of signal flow 1400 can be implemented by part(s) of system architecture 100 of FIG. 1 to facilitate dynamic selection of sounding reference signal frequency hopping configurations.

As depicted, in signal flow 1100, 1200, 1300, and 1400, communications are sent between UE 1102, gNB 1104, and 5G core (5GC) 1106 (which comprises access and mobility management function (AMF) 1108 and user plane function (UPF) 1110).

The signal flow of signal flow 1100, 1200, 1300, and 1400 is an example signal flow, and there can be signal flows that implement different signals, or the signals of signal flow 1100 and 1000 in a different order, as part of facilitating detecting unresponsive user equipment.

As depicted in signal flow 1100 and 1000, the following occurs:
5G-NR RRC connection setup 1112
Msg1: Preamble 1114
Allocate temporary cell radio-network temporary identifier (C-RNTI) 1116
Physical downlink control channel (PDCCH) downlink control information (DCI) Format 1_0 [random access radio network temporary identifier (RA_RNTI)] 1118
Msg2: Random Access Response 1120
Msg3: RRCSetupRequest 1122
PDCCH DCI Format 1_0 [C_RNTI] 1124
Msg4: RRCSetup 1126
PDCCH DCI Format 0_0 [C_RNTI] 1128
RRCSetupComplete 1130
AMF selection 1132
Initial UE message 1134 [non-access-stratum-protocol data unit (NAS-PDU): Registration Request]
NAS identity request/response 1136
NAS authentication request/response 1138
NAS security mode command/complete 1140
UE capability enquiry 1142
UE capability information 1144 (containing dynamicSrsFrequencyHoppingSwitchSupport [Supported] IE in FeatureSetUplink for uplink)
Initial context setup request 1146 [NAS-PDU: Registration Accept]
RRCReconfiguration 1148 (srs-Config with resourceType=Periodic in BWP-UplinkDedicated IE for Pcell and Scells if UE supports SRS feature in uplink)
RRCReconfigurationComplete 1150
Initial context setup response 1151
SA UE attach procedure completed 1152
Uplink secondary cells activation procedure 1153
Condition met to activate secondary cells 1154
Trigger Scell activation MAC-CE 1155.
PDCCH DCI Format 0_1 for Pcell 1156 [C_RNTI]
PDCCH DCI Format 0_1 for Scell 1157 [C_RNTI]
Uplink data on Pcell 1158 [MAC PDU contains PUSCH]
Uplink data on Scells 1159 [MAC PDU contains PUSCH]
Uplink data 1160
Uplink data 1161
Start uplink data transfer & SRS channel quality reporting 1162
Uplink data 1163
Uplink data 1164
PDCCH DCI format 0_1 on Pcell 1165 [C_RNTI]
Uplink data on Pcell 1166 [MAC PDU contains PUSCH]
PDCCH DCI Format 0_1 for Scell 1167 [C_RNTI]
Uplink data on Scells 1168 [MAC PDU contains PUSCH]
CRC status=PASS for UL PUSCH data for Pcell and Scells 1169
Uplink data 1170
Uplink data 1171
SRS report for Pcell & Scells for wideband 1172 [SNR>=10]
UL data decoding failed at gNB for Pcell and/or Scells 1173
SRS report for Pcell & Scells for wideband [SNR=5, 4, . . . ] 1174.
Channel condition getting worse and not in position to measure the wideband 1175
SRS report for Pcell & Scells for wideband [SNR=4, 2, 1, 0, −1, . . . ] 1176
PDCCH DCI format 0_1 for Pcell & Scells 1177 [C_RNTI]
Uplink data on Pcell & Scells 1178 [MAC PDU contains PUSCH]
CRC status=FAIL for UL PUSCH/PUCCH and SRS indication data because of low SNR for Pcell and/or Scells 1179
Trigger/change SRS frequency hopping configuration in using MAC-CE because of a following condition being met: (1) UL SINR reporting is bad/good for certain thresholds and periods; (2) UL CRC=FAIL because SINR is low for wideband reporting; (3) UE is on cell edge; (4) UE is on high mobility, hence fast changing ratio condition 1180
Uplink data on Pcell & Scells 1181
UE decodes MAC-CE received and applies the new configuration; based on that, UE will start SRS reporting 1182
Activation/deactivation of SRS frequency hopping using MAC-CE for Pcell 1183 [based on number of Scells, different MAC-CEs can be scheduled by gNB]
Activation/deactivation of SRS frequency hopping using MAC-CE for Scell 1184 [based on number of Scells, different MAC-CEs can be scheduled by gNB]
Modify the SRS frequency hopping configuration to avoid UE battery drain 1185
PDCCH DCI format 0_1 on Pcell & Scells 1186 [C_RNTI]
Uplink data on Pcell & Scells 1187 [MAC PDU contains PUSCH]
CRC status=PASS for UL PUSCH data for Pcell and Scells 1188
Uplink data on Pcell 1189
Uplink data on Scells 1190
Uplink data 1191
Improvement seen in CRC PASS for UL data on Pcell and Scells 1192
UL data transfer continues 1193

### EXAMPLE PROCESS FLOWS

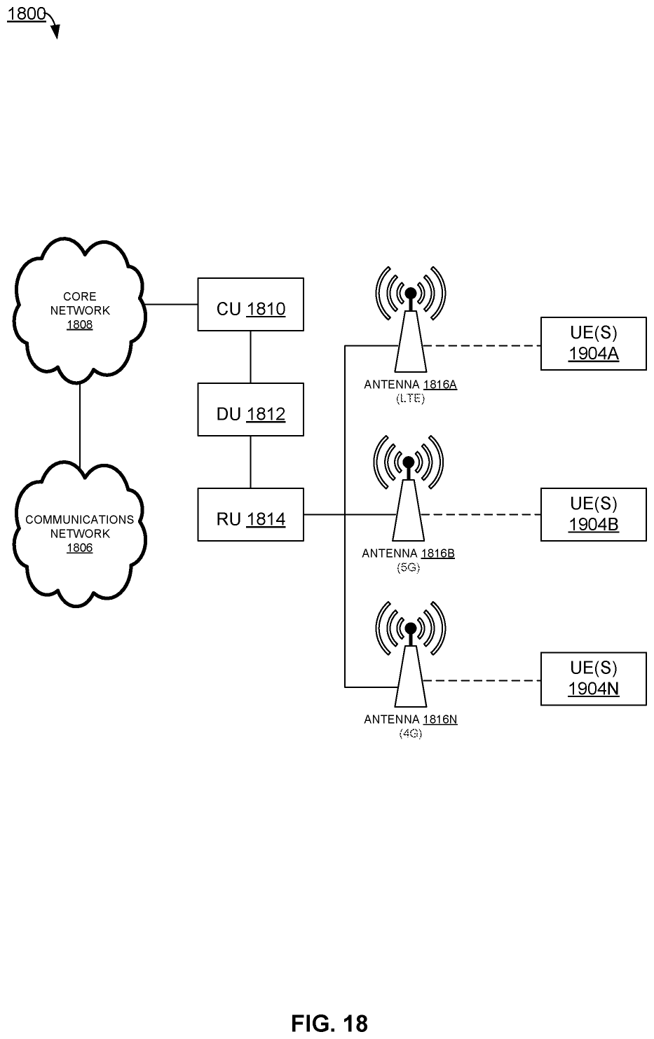

FIG. 15 illustrates an example process flow 1500 that can facilitate dynamic selection of sounding reference signal frequency hopping configurations, in accordance with an embodiment of this disclosure. In some examples, one or more embodiments of process flow 1500 can be implemented by dynamic selection of sounding reference signal frequency hopping configurations component 108 of FIG. 1, or computing environment 1800 of FIG. 18.

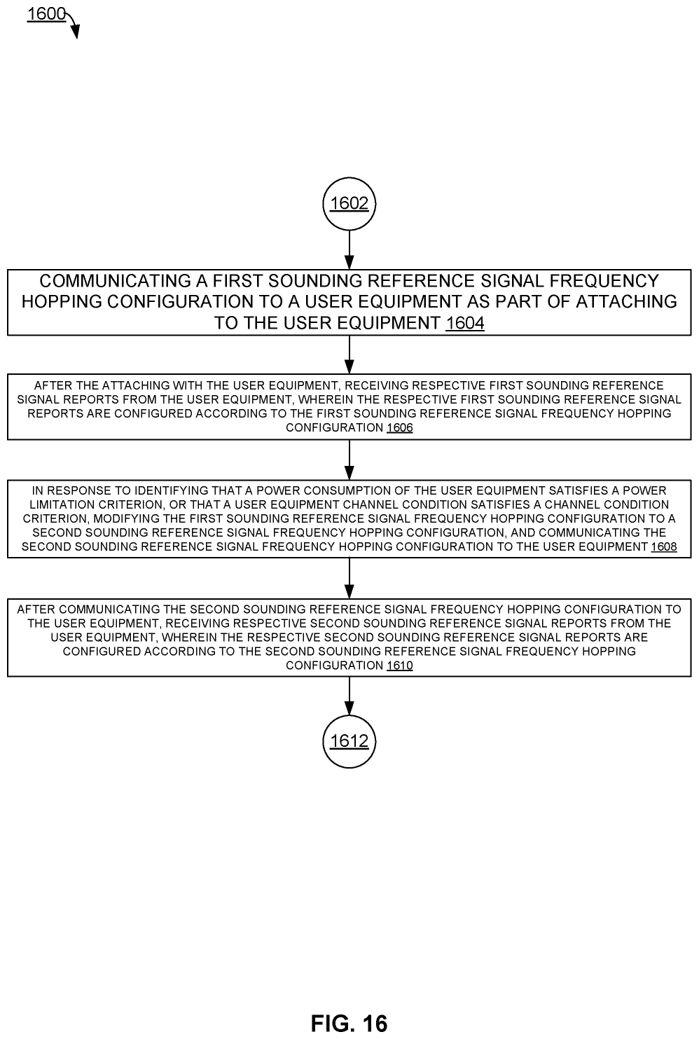

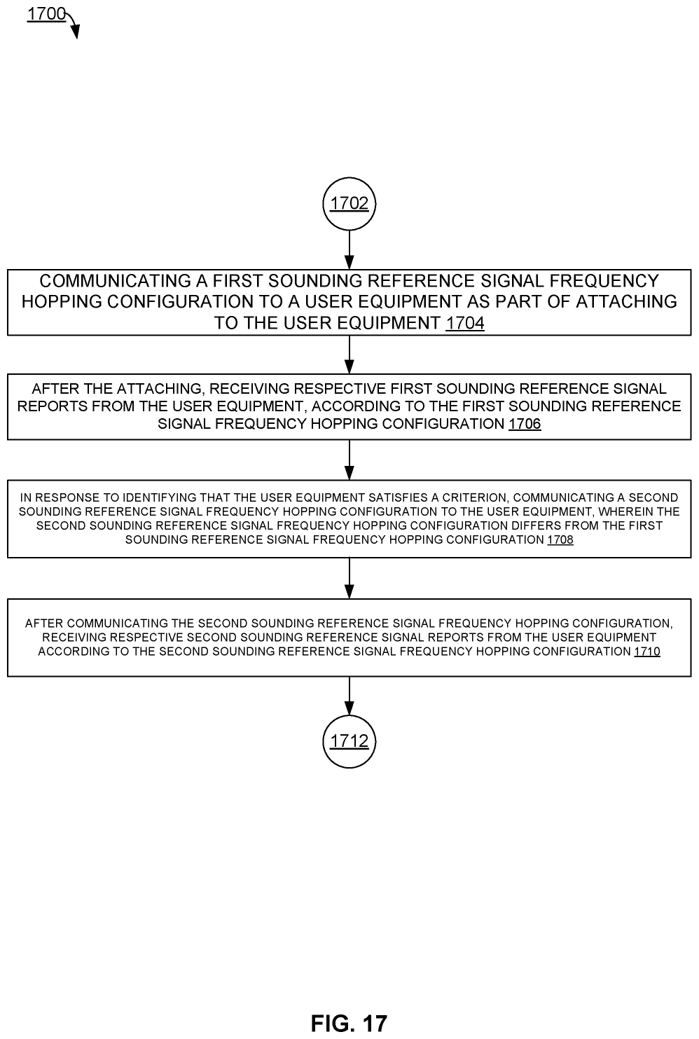

It can be appreciated that the operating procedures of process flow 1500 are example operating procedures, and that there can be embodiments that implement more or fewer operating procedures than are depicted, or that implement the depicted operating procedures in a different order than as depicted. In some examples, process flow 1500 can be implemented in conjunction with one or more embodiments of one or more of process flow 1600 of FIG. 16, and/or process flow 1700 of FIG. 17.

Process flow 1500 begins with 1502, and moves to operation 1504.

Operation 1504 depicts, as part of attaching with a user equipment, determining a first sounding reference signal frequency hopping configuration for communications with the user equipment, and communicating the first sounding reference signal frequency hopping configuration to the user equipment.

In an example that uses DCI messaging, this can be performed in a similar manner as operations 702-752 of FIG. 7, where the first sounding reference signal frequency hopping configuration can be communicated as part of RRCReconfiguration 748 (srs-Config with resourceType=Periodic in BWP-UplinkDedicated IE for Pcell and Scells if UE supports SRS feature in uplink). In an example that uses MAC-CE messaging, this can be performed in a similar manner as operations 1202-1252 of FIG. 12, where the first sounding reference signal frequency hopping configuration can be communicated as part of RRCReconfiguration 1248 (srs-Config with resourceType=Periodic in BWP-UplinkDedicated IE for Pcell and Scells if UE supports SRS feature in uplink).

After operation 1504, process flow 1500 moves to operation 1506.

Operation 1506 depicts, after the attaching with the user equipment, receiving respective first sounding reference signal reports from the user equipment, wherein the respective first sounding reference signal reports are configured according to the first sounding reference signal frequency hopping configuration.

Continuing with the example of FIG. 7, these first sounding reference signal reports can be similar to SRS report for Pcell & Scells for wideband 772 [SNR>=10]; SRS report for Pcell & Scells for wideband [SNR=5, 4, . . . ] 774; and/or SRS report for Pcell & Scells for wideband [SNR=4, 2, 1, 0, −1, . . . ] 776. And continuing with the example of FIG. 7, these first sounding reference signal reports can be similar to SRS report for Pcell & Scells for wideband 1272 [SNR>=10]; SRS report for Pcell & Scells for wideband [SNR=5, 4, . . . ] 1274; and SRS report for Pcell & Scells for wideband [SNR=4, 2, 1, 0, −1, . . . ] 1276.

After operation 1506, process flow 1500 moves to operation 1508.

Operation 1508 depicts, in response to identifying that a power consumption of the user equipment satisfies a power limitation criterion, or that a user equipment channel condition satisfies a channel condition criterion, modifying the first sounding reference signal frequency hopping configuration to a second sounding reference signal frequency hopping configuration, and communicating the second sounding reference signal frequency hopping configuration to the user equipment.

Continuing with the example of FIG. 7, this can be performed in a similar manner as trigger/change SRS frequency hopping configuration in using DCI because of a following condition being met: (1) UL SINR reporting is bad/good for certain thresholds and periods; (2) UL CRC=FAIL because SINR is low for wideband reporting; (3) UE is on cell edge; (4) UE is on high mobility, hence fast changing ratio condition 780; UE decodes cSRS, bSRS, bHop fields received for DU/UL direction in DCI format 1_1/0_1 for Pcell and Scells 782; Trigger PDCCH DCI format 0_1/1_1 for Pcell [with cSRS, bSRS, bHop fields with SRS sub-band configurations 783; trigger PDCCH DCI format 0_1/1_1 for Scells [with cSRS, bSRS, bHop fields with SRS sub-band configurations 784; and identify the SRS frequency hopping configuration to avoid UE battery drain for Pcell and Scells 785.

Continuing with the example of FIG. 12, this can be performed in a similar manner as trigger/change SRS frequency hopping configuration in using MAC-CE because of a following condition being met: (1) UL SINR reporting is bad/good for certain thresholds and periods; (2) UL CRC=FAIL because SINR is low for wideband reporting; (3) UE is on cell edge; (4) UE is on high mobility, hence fast changing ratio condition 1280; UE decodes MAC-CE received and applies the new configuration; based on that, UE will start SRS reporting 1282; activation/deactivation of SRS frequency hopping using MAC-CE for Pcell 1283 [based on number of Scells, different MAC-CEs can be scheduled by gNB]; activation/deactivation of SRS frequency hopping using MAC-CE for Scell 1284 [based on number of Scells, different MAC-CEs can be scheduled by gNB]; and modify the SRS frequency hopping configuration to avoid UE battery drain 1285.

In some examples, communicating the second sounding reference signal frequency hopping configuration to the user equipment is performed via a medium access control control element message. That is, MAC-CE messaging can be used to dynamically modify an SRS frequency hopping configuration.

In some examples, communicating the second sounding reference signal frequency hopping configuration to the user equipment is performed via a downlink control information message. That is, DCI messaging can be used to dynamically modify an SRS frequency hopping configuration.

In some examples, the first sounding reference signal frequency hopping configuration corresponds to a full bandwidth of the user equipment, the power consumption of the user equipment satisfies the power limitation criterion, and operation 1508 comprises determining that the second sounding reference signal frequency hopping configuration corresponds to a sub-bandwidth of the user equipment based on the user equipment satisfying the power limitation criterion, and before modifying the first sounding reference signal frequency hopping configuration to the second sounding reference signal frequency hopping configuration. That is, in examples where a UE battery can drain quickly, a gNB can perform a procedure so that the UE can conserve energy, and this can involve changing SRS-Resource.freqHopping parameters dynamically to measure the sub-band instead of full band overcome with this issue.

In some examples, the first sounding reference signal frequency hopping configuration corresponds to a full bandwidth of the user equipment, the user equipment channel condition satisfies the channel condition criterion, and operation 1508 comprises determining that the second sounding reference signal frequency hopping configuration corresponds to a sub-bandwidth of the user equipment based on the user equipment channel condition satisfying the power limitation criterion, and before modifying the first sounding reference signal frequency hopping configuration to the second sounding reference signal frequency hopping configuration. That is, when a UE is in a high mobility scenario, a channel/radio condition can vary frequently, and, in that case, measuring and estimating channel quality for the SRS full band could be difficult for UE. In such a scenario, a gNB can change the SRS frequency hopping configuration so that UE can just measure sub band and report that to the gNB.

In some examples, the channel condition criterion corresponds to a defined high mobility status of the user equipment. That is, a high mobility scenario can lead to changing an SRS frequency hopping configuration.

In some examples, the channel condition criterion corresponds to a physical location of the user equipment being located at a cell edge of a cellular network that is facilitated. That is, a UE being physically located at a cell edge can lead to changing an SRS frequency hopping configuration.

After operation 1508, process flow 1500 moves to operation 1510.

Operation 1510 depicts, after communicating the second sounding reference signal frequency hopping configuration to the user equipment, receiving respective second sounding reference signal reports from the user equipment, wherein the respective second sounding reference signal reports are configured according to the second sounding reference signal frequency hopping configuration.

Continuing with the example of FIG. 7, this can be performed in a similar manner as uplink data on Pcell & Scells 787 [MAC PDU contains PUSCH]; CRC status=PASS for UL PUSCH data for Pcell and Scells 788; uplink data on Pcell 789; uplink data on Scells 790; Uplink data 791; and improvement seen in CRC PASS for UL data on Pcell and Scells 792—where UE 702 sends gNB 704 SRS reports as part of these communications.

Continuing with the example of FIG. 7, this can be performed in a similar manner as uplink data on Pcell & Scells 1287 [MAC PDU contains PUSCH]; CRC status=PASS for UL PUSCH data for Pcell and Scells 1288; uplink data on Pcell 1289; uplink data on Scells 1290; uplink data 1291; and improvement seen in CRC PASS for UL data on Pcell and Scells 1292—where UE 1202 sends gNB 1204 SRS reports as part of these communications.

After operation 1510, process flow 1500 moves to 1512, where process flow 1500 ends.

FIG. 16 illustrates an example process flow 1600 that can facilitate dynamic selection of sounding reference signal frequency hopping configurations, in accordance with an embodiment of this disclosure. In some examples, one or more embodiments of process flow 1600 can be implemented by dynamic selection of sounding reference signal frequency hopping configurations component 108 of FIG. 1, or computing environment 1800 of FIG. 18.

It can be appreciated that the operating procedures of process flow 1600 are example operating procedures, and that there can be embodiments that implement more or fewer operating procedures than are depicted, or that implement the depicted operating procedures in a different order than as depicted. In some examples, process flow 1600 can be implemented in conjunction with one or more embodiments of one or more of process flow 1500 of FIG. 15, and/or process flow 1700 of FIG. 17.

Process flow 1600 begins with 1602, and moves to operation 1604.

Operation 1604 depicts communicating a first sounding reference signal frequency hopping configuration to a user equipment as part of attaching to the user equipment. In some examples, operation 1604 can be implemented in a similar manner as operation 1504 of FIG. 15.

In some examples, operation 1604 comprises receiving, from the user equipment, an indication that the user equipment supports sounding reference signal frequency hopping in uplink communications as part of attaching to the user equipment. In some examples, a communication that indicates a group of features supported by the user equipment for the uplink communications comprises the indication. In some examples, the indication comprises an information element. In some examples, this can comprise an IE within FeatureSetUplink, such as in the example of FIG. 6.

After operation 1604, process flow 1600 moves to operation 1606.

Operation 1606 depicts, after the attaching with the user equipment, receiving respective first sounding reference signal reports from the user equipment, wherein the respective first sounding reference signal reports are configured according to the first sounding reference signal frequency hopping configuration. In some examples, operation 1606 can be implemented in a similar manner as operation 1506 of FIG. 15.

After operation 1606, process flow 1600 moves to operation 1608.

Operation 1608 depicts, in response to identifying that a power consumption of the user equipment satisfies a power limitation criterion, or that a user equipment channel condition satisfies a channel condition criterion, modifying the first sounding reference signal frequency hopping configuration to a second sounding reference signal frequency hopping configuration, and communicating the second sounding reference signal frequency hopping configuration to the user equipment. In some examples, operation 1608 can be implemented in a similar manner as operation 1508 of FIG. 15.

In some examples, the system facilitates a cellular network that comprises a primary cell and a group of secondary cells, and communicating the second sounding reference signal frequency hopping configuration to the user equipment comprises sending, to the user equipment, a first communication indicative of using the second sounding reference signal frequency hopping configuration with the primary cell, and sending, to the user equipment, a second communication indicative of using the second sounding reference signal frequency hopping configuration with the group of secondary cells.

In some examples that use a MAC-CE message, these communications can be similar to activation/deactivation of SRS frequency hopping using MAC-CE for Pcell 1283 of FIG. 12 [based on number of Scells, different MAC-CEs can be scheduled by gNB], and activation/deactivation of SRS frequency hopping using MAC-CE for Scell 1284 [based on number of Scells, different MAC-CEs can be scheduled by gNB], respectively. In some examples that use a DCI message, these communications can be similar to trigger PDCCH DCI format 0_1/1_1 for Pcell [with cSRS, bSRS, bHop fields with SRS sub-band configurations 783 of FIG. 7, and trigger PDCCH DCI format 0_1/1_1 for Scells [with cSRS, bSRS, bHop fields with SRS sub-band configurations 784, respectively.

In some examples, the system facilitates a cellular network that comprises a primary cell and a group of secondary cells, and communicating the second sounding reference signal frequency hopping configuration to the user equipment comprises communicating separate c-srs, b-srs, and b-hop values for the primary cell and for at least one respective secondary cell for the group of secondary cells. That is, it can be that each cell can have its own SRS frequency hopping configuration for a given UE.

In some examples the at least one respective secondary cell is a first secondary cell, and an omitted c-srs, b-srs, or b-hop value of a second secondary cell of the group of secondary cells indicates maintaining a current c-srs, b-srs, or b-hop value. That is, where an SRS frequency hopping configuration is updated, and the update does not specify a value for a particular parameter, the current value for that parameter can be maintained.

After operation 1608, process flow 1600 moves to operation 1610.

Operation 1610 depicts after communicating the second sounding reference signal frequency hopping configuration to the user equipment, receiving respective second sounding reference signal reports from the user equipment, wherein the respective second sounding reference signal reports are configured according to the second sounding reference signal frequency hopping configuration. In some examples, operation 1610 can be implemented in a similar manner as operation 1610 of FIG. 15.

After operation 1610, process flow 1600 moves to 1612, where process flow 1600 ends.

FIG. 17 illustrates an example process flow 1700 that can facilitate dynamic selection of sounding reference signal frequency hopping configurations, in accordance with an embodiment of this disclosure. In some examples, one or more embodiments of process flow 1700 can be implemented by dynamic selection of sounding reference signal frequency hopping configurations component 108 of FIG. 1, or computing environment 1800 of FIG. 18.

It can be appreciated that the operating procedures of process flow 1700 are example operating procedures, and that there can be embodiments that implement more or fewer operating procedures than are depicted, or that implement the depicted operating procedures in a different order than as depicted. In some examples, process flow 1700 can be implemented in conjunction with one or more embodiments of one or more of process flow 1500 of FIG. 15, and/or process flow 1600 of FIG. 16.

Process flow 1700 begins with 1702, and moves to operation 1704.

Operation 1704 depicts communicating a first sounding reference signal frequency hopping configuration to a user equipment as part of attaching to the user equipment. In some examples, operation 1704 can be implemented in a similar manner as operation 1504 of FIG. 15.

After operation 1704, process flow 1700 moves to operation 1706.

Operation 1706 depicts, after the attaching, receiving respective first sounding reference signal reports from the user equipment, according to the first sounding reference signal frequency hopping configuration. In some examples, operation 1706 can be implemented in a similar manner as operation 1506 of FIG. 15.

After operation 1706, process flow 1700 moves to operation 1708.

Operation 1708 depicts, in response to identifying that the user equipment satisfies a criterion, communicating a second sounding reference signal frequency hopping configuration to the user equipment, wherein the second sounding reference signal frequency hopping configuration differs from the first sounding reference signal frequency hopping configuration. In some examples, operation 1708 can be implemented in a similar manner as operation 1508 of FIG. 15.

In some examples, the second sounding reference signal frequency hopping configuration comprises a c-srs value. In examples that utilize a MAC-CE message, this can be similar to a c-srs value as illustrated in FIGS. 3-5. In examples that utilize a DCI message, this can be similar to a c-srs value indicated in a PDCCH DCI Format 0_1/1_1 message for a Pcell (883 of FIG. 10) or a Scell (884 of FIG. 10).

In some examples, the second sounding reference signal frequency hopping configuration comprises a b-srs value. In examples that utilize a MAC-CE message, this can be similar to a b-srs value as illustrated in FIGS. 3-5. In examples that utilize a DCI message, this can be similar to a c-srs value indicated in a PDCCH DCI Format 0_1/1_1 message for a Pcell (883 of FIG. 10) or a Scell (884 of FIG. 10).

In some examples, the second sounding reference signal frequency hopping configuration comprises a b-hop value. In examples that utilize a MAC-CE message, this can be similar to a b-hop value as illustrated in FIGS. 3-5. In examples that utilize a DCI message, this can be similar to a c-srs value indicated in a PDCCH DCI Format 0_1/1_1 message for a Pcell (883 of FIG. 10) or a Scell (884 of FIG. 10).

In some examples, the criterion corresponds to a power consumption of the user equipment. In some examples, the criterion corresponds to a user equipment channel condition that corresponds to the user equipment.

After operation 1708, process flow 1700 moves to operation 1710.

Operation 1710 depicts, after communicating the second sounding reference signal frequency hopping configuration, receiving respective second sounding reference signal reports from the user equipment according to the second sounding reference signal frequency hopping configuration. In some examples, operation 1710 can be implemented in a similar manner as operation 1510 of FIG. 15.

After operation 1710, process flow 1700 moves to 1712, where process flow 1700 ends.

### EXAMPLE OPERATING ENVIRONMENT

In order to provide additional context for various embodiments described herein, FIG. 18 and the following discussion are intended to provide a brief, general description of a suitable computing environment 1800 in which the various embodiments of the embodiment described herein can be implemented.

For example, parts of computing environment 1800 can be used to implement one or more embodiments of gNB 102, Pcell 104, Scell(s) 106, dynamic selection of sounding reference signal frequency hopping configurations component 108, and UE 110.

In some examples, computing environment 1800 can implement one or more embodiments of the process flows of FIGS. 15-17 to facilitate dynamic selection of sounding reference signal frequency hopping configurations.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 18, the example environment 1800 for implementing various embodiments described herein includes a computer 1802, the computer 1802 including a processing unit 1804, a system memory 1806 and a system bus 1808. The system bus 1808 couples system components including, but not limited to, the system memory 1806 to the processing unit 1804. The processing unit 1804 can be any of various commercially available processors. Dual microprocessors and other multi-processor architectures can also be employed as the processing unit 1804.

The system bus 1808 can be any of several types of bus structure that can further interconnect to a memory bus (with or without a memory controller), a peripheral bus, and a local bus using any of a variety of commercially available bus architectures. The system memory 1806 includes ROM 1810 and RAM 1812. A basic input/output system (BIOS) can be stored in a nonvolatile storage such as ROM, erasable programmable read only memory (EPROM), EEPROM, which BIOS contains the basic routines that help to transfer information between elements within the computer 1802, such as during startup. The RAM 1812 can also include a high-speed RAM such as static RAM for caching data.

The computer 1802 further includes an internal hard disk drive (HDD) 1814 (e.g., EIDE, SATA), one or more external storage devices 1816 (e.g., a magnetic floppy disk drive (FDD) 1816, a memory stick or flash drive reader, a memory card reader, etc.) and an optical disk drive 1820 (e.g., which can read or write from a CD-ROM disc, a DVD, a BD, etc.). While the internal HDD 1814 is illustrated as located within the computer 1802, the internal HDD 1814 can also be configured for external use in a suitable chassis (not shown). Additionally, while not shown in environment 1800, a solid state drive (SSD) could be used in addition to, or in place of, an HDD 1814. The HDD 1814, external storage device(s) 1816 and optical disk drive 1820 can be connected to the system bus 1808 by an HDD interface 1824, an external storage interface 1826 and an optical drive interface 1828, respectively. The interface 1824 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1802, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1812, including an operating system 1830, one or more application programs 1832, other program modules 1834 and program data 1836. All or portions of the operating system, applications, modules, and/or data can also be cached in the RAM 1812. The systems and methods described herein can be implemented utilizing various commercially available operating systems or combinations of operating systems.

Computer 1802 can optionally comprise emulation technologies. For example, a hypervisor (not shown) or other intermediary can emulate a hardware environment for operating system 1830, and the emulated hardware can optionally be different from the hardware illustrated in FIG. 18. In such an embodiment, operating system 1830 can comprise one virtual machine (VM) of multiple VMs hosted at computer 1802. Furthermore, operating system 1830 can provide runtime environments, such as the Java runtime environment or the .NET framework, for applications 1832. Runtime environments are consistent execution environments that allow applications 1832 to run on any operating system that includes the runtime environment. Similarly, operating system 1830 can support containers, and applications 1832 can be in the form of containers, which are lightweight, standalone, executable packages of software that include, e.g., code, runtime, system tools, system libraries and settings for an application.

Further, computer 1802 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1802, e.g., applied at the application execution level or at the operating system (OS) kernel level, thereby enabling security at any level of code execution.

A user can enter commands and information into the computer 1802 through one or more wired/wireless input devices, e.g., a keyboard 1838, a touch screen 1840, and a pointing device, such as a mouse 1842. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1804 through an input device interface 1844 that can be coupled to the system bus 1808, but can be connected by other interfaces, such as a parallel port, an IEEE 1394 serial port, a game port, a USB port, an IR interface, a BLUETOOTH® interface, etc.

A monitor 1846 or other type of display device can be also connected to the system bus 1808 via an interface, such as a video adapter 1848. In addition to the monitor 1846, a computer typically includes other peripheral output devices (not shown), such as speakers, printers, etc.

The computer 1802 can operate in a networked environment using logical connections via wired and/or wireless communications to one or more remote computers, such as a remote computer(s) 1850. The remote computer(s) 1850 can be a workstation, a server computer, a router, a personal computer, portable computer, microprocessor-based entertainment appliance, a peer device or other common network node, and typically includes many or all of the elements described relative to the computer 1802, although, for purposes of brevity, only a memory/storage device 1852 is illustrated. The logical connections depicted include wired/wireless connectivity to a local area network (LAN) 1854 and/or larger networks, e.g., a wide area network (WAN) 1856. Such LAN and WAN networking environments are commonplace in offices and companies, and facilitate enterprise-wide computer networks, such as intranets, all of which can connect to a global communications network, e.g., the Internet.

When used in a LAN networking environment, the computer 1802 can be connected to the local network 1854 through a wired and/or wireless communication network interface or adapter 1858. The adapter 1858 can facilitate wired or wireless communication to the LAN 1854, which can also include a wireless access point (AP) disposed thereon for communicating with the adapter 1858 in a wireless mode.

When used in a WAN networking environment, the computer 1802 can include a modem 1860 or can be connected to a communications server on the WAN 1856 via other means for establishing communications over the WAN 1856, such as by way of the Internet. The modem 1860, which can be internal or external and a wired or wireless device, can be connected to the system bus 1808 via the input device interface 1844. In a networked environment, program modules depicted relative to the computer 1802 or portions thereof, can be stored in the remote memory/storage device 1852. It will be appreciated that the network connections shown are examples, and other means of establishing a communications link between the computers can be used.

When used in either a LAN or WAN networking environment, the computer 1802 can access cloud storage systems or other network-based storage systems in addition to, or in place of, external storage devices 1816 as described above. Generally, a connection between the computer 1802 and a cloud storage system can be established over a LAN 1854 or WAN 1856 e.g., by the adapter 1858 or modem 1860, respectively. Upon connecting the computer 1802 to an associated cloud storage system, the external storage interface 1826 can, with the aid of the adapter 1858 and/or modem 1860, manage storage provided by the cloud storage system as it would other types of external storage. For instance, the external storage interface 1826 can be configured to provide access to cloud storage sources as if those sources were physically connected to the computer 1802.

The computer 1802 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a processor; and
a memory that stores executable instructions that, when executed by the processor, facilitate performance of operations, comprising:
as part of attaching with a user equipment,
determining a first sounding reference signal frequency hopping configuration for communications with the user equipment, and
communicating the first sounding reference signal frequency hopping configuration to the user equipment;
after the attaching with the user equipment, receiving respective first sounding reference signal reports from the user equipment, wherein the respective first sounding reference signal reports are configured according to the first sounding reference signal frequency hopping configuration;
in response to identifying that a power consumption of the user equipment satisfies a power limitation criterion, or that a user equipment channel condition satisfies a channel condition criterion,
modifying the first sounding reference signal frequency hopping configuration to a second sounding reference signal frequency hopping configuration, and
communicating the second sounding reference signal frequency hopping configuration to the user equipment; and
after communicating the second sounding reference signal frequency hopping configuration to the user equipment, receiving respective second sounding reference signal reports from the user equipment, wherein the respective second sounding reference signal reports are configured according to the second sounding reference signal frequency hopping configuration.

2. The system of claim 1, wherein communicating the second sounding reference signal frequency hopping configuration to the user equipment is performed via a medium access control control element message.

3. The system of claim 1, wherein communicating the second sounding reference signal frequency hopping configuration to the user equipment is performed via a downlink control information message.

4. The system of claim 1, wherein the first sounding reference signal frequency hopping configuration corresponds to a full bandwidth of the user equipment, wherein the power consumption of the user equipment satisfies the power limitation criterion, and wherein the operations further comprise:
determining that the second sounding reference signal frequency hopping configuration corresponds to a sub-bandwidth of the user equipment based on the user equipment satisfying the power limitation criterion, and before modifying the first sounding reference signal frequency hopping configuration to the second sounding reference signal frequency hopping configuration.

5. The system of claim 1, wherein the first sounding reference signal frequency hopping configuration corresponds to a full bandwidth of the user equipment, wherein the user equipment channel condition satisfies the channel condition criterion, and wherein the operations further comprise:
determining that the second sounding reference signal frequency hopping configuration corresponds to a sub-bandwidth of the user equipment based on the user equipment channel condition satisfying the power limitation criterion, and before modifying the first sounding reference signal frequency hopping configuration to the second sounding reference signal frequency hopping configuration.

6. The system of claim 1, wherein the channel condition criterion corresponds to a defined high mobility status of the user equipment.

7. The system of claim 1, wherein the channel condition criterion corresponds to a physical location of the user equipment being located at a cell edge of a cellular network that is facilitated by the system.

8. A method, comprising:
communicating, by a system, a first sounding reference signal frequency hopping configuration to a user equipment as part of attaching to the user equipment;
after the attaching with the user equipment, receiving, by the system, respective first sounding reference signal reports from the user equipment, wherein the respective first sounding reference signal reports are configured according to the first sounding reference signal frequency hopping configuration;
in response to identifying that a power consumption of the user equipment satisfies a power limitation criterion, or that a user equipment channel condition satisfies a channel condition criterion,
modifying, by the system, the first sounding reference signal frequency hopping configuration to a second sounding reference signal frequency hopping configuration, and
communicating, by the system, the second sounding reference signal frequency hopping configuration to the user equipment; and
after communicating the second sounding reference signal frequency hopping configuration to the user equipment, receiving, by the system, respective second sounding reference signal reports from the user equipment, wherein the respective second sounding reference signal reports are configured according to the second sounding reference signal frequency hopping configuration.

9. The method of claim 8, further comprising:
receiving, by the system from the user equipment, an indication that the user equipment supports sounding reference signal frequency hopping in uplink communications as part of attaching to the user equipment.

10. The method of claim 9, wherein a communication that indicates a group of features supported by the user equipment for the uplink communications comprises the indication.

11. The method of claim 10, wherein the indication comprises an information element.

12. The method of claim 10, wherein the system facilitates a cellular network that comprises a primary cell and a group of secondary cells, and wherein communicating the second sounding reference signal frequency hopping configuration to the user equipment comprises:
sending, by the system to the user equipment, a first communication indicative of using the second sounding reference signal frequency hopping configuration with the primary cell; and
sending, by the system to the user equipment, a second communication indicative of using the second sounding reference signal frequency hopping configuration with the group of secondary cells.

13. The method of claim 8, wherein the system facilitates a cellular network that comprises a primary cell and a group of secondary cells, and wherein communicating the second sounding reference signal frequency hopping configuration to the user equipment comprises communicating separate c-srs, b-srs, and b-hop values for the primary cell and for at least one respective secondary cell for the group of secondary cells.

14. The method of claim 18, wherein the at least one respective secondary cell is a first secondary cell, and wherein an omitted c-srs, b-srs, or b-hop value of a second secondary cell of the group of secondary cells indicates maintaining a current c-srs, b-srs, or b-hop value.

15. A non-transitory computer-readable medium comprising instructions that, in response to execution, cause a system comprising a processor to perform operations, comprising:
communicating a first sounding reference signal frequency hopping configuration to a user equipment as part of attaching to the user equipment;
after the attaching, receiving respective first sounding reference signal reports from the user equipment, according to the first sounding reference signal frequency hopping configuration;
in response to identifying that the user equipment satisfies a criterion, communicating a second sounding reference signal frequency hopping configuration to the user equipment, wherein the second sounding reference signal frequency hopping configuration differs from the first sounding reference signal frequency hopping configuration; and
after communicating the second sounding reference signal frequency hopping configuration, receiving respective second sounding reference signal reports from the user equipment according to the second sounding reference signal frequency hopping configuration.

16. The non-transitory computer-readable medium of claim 15, wherein the second sounding reference signal frequency hopping configuration comprises a c-srs value.

17. The non-transitory computer-readable medium of claim 15, wherein the second sounding reference signal frequency hopping configuration comprises a b-srs value.

18. The non-transitory computer-readable medium of claim 15, wherein the second sounding reference signal frequency hopping configuration comprises a b-hop value.

19. The non-transitory computer-readable medium of claim 15, wherein the criterion corresponds to a power consumption of the user equipment.

20. The non-transitory computer-readable medium of claim 15, wherein the criterion corresponds to a user equipment channel condition that corresponds to the user equipment.
